(19) United States
(12) Patent Application Publication
(10) Pub. No.: US 2005/0238840 A1
(43) Pub. Date: Oct. 27, 2005

(54) High-performance optical storage media

(76) Inventors: Urs Lehmann, Basel (CH); Peter Aeschlimann, Allschwil (CH); Jean-Luc Budry, Rossemaison (CH); Beat Schmidhalter, Bubendorf (CH); Colin Morton, Basel (CH)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/514,923

(22) PCT Filed: Apr. 15, 2003
(86) PCT No.: PCT/EP03/03946

§ 371 Date: Nov. 12, 2004

(30) Foreign Application Priority Data
May 17, 2002 (CH) 0829/02-02

(51) Int. Cl. G11B 7/24

(52) U.S. Cl. 428/64.8; 430/270.15; 369/284; 430/945

(57) ABSTRACT

The invention relates to an optical recording medium comprising a substrate, a reflecting layer and a recording layer, wherein the recording layer comprises a compound of formula: (Formula I), (Formula II) or (Formula III); wherein R, to R, may be hydrogen or a variety of substituents, but R₁ and R₉ are not simultaneously hydrogen; Y^{m-}— is an inorganic, organic or organometallic anion, or a mixture thereof; Zⁿ⁺ is a proton or a metal, ammonium or phosphonium cation, or a mixture thereof; m, n and o are each independently of the others an integer from 1 to 3; and p and q are each a number from 0 to 4, the ratio of o, p and q to one another, depending on the charge of the associated sub-structures, being such that there is no excess positive or negative charge in formula (I), (II) or (III). Also claimed are the use of a xanthene perchlorate in the preparation of compounds of formula (I), (II) or (III) having organometallic anions, and the use of lactates in the application of layers of dye of compounds of formula (I), (II) or (III) to grooved substrates by spin-coating.

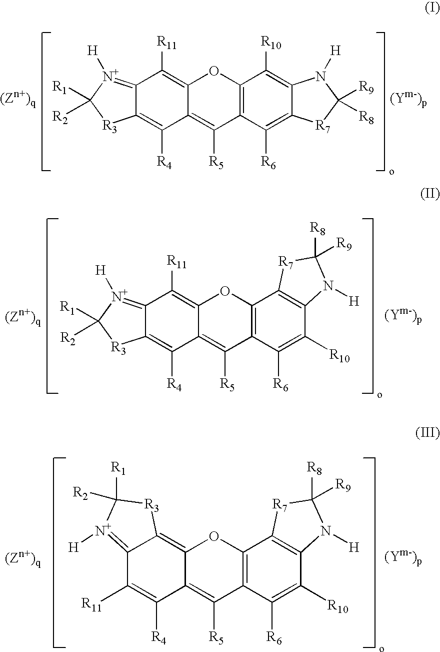

The field of the invention is the optical storage of information on write-once storage media, the information pits being differentiated by the different optical properties of a colorant at written and unwritten sites. This technology is usually termed “WORM” (for example “CD-R” or “DVD-R”); those terms have been adopted herein.

By using more recent compact high-performance red diode lasers that emit in the range of from 630 to 690 nm, it is possible in principle to achieve a 6- to 8-fold increase in data packing density compared with media having a blue or green coating, in that the track spacing (distance between two turns of the information track) and the size of the pits can be reduced, for example, to approximately half the value in comparison with conventional CDs.

This imposes extraordinarily high demands on the recording layer to be used, however, such as high refractive index, uniformity of script width at different-length pulse durations and also high light stability in daylight with, at the same time, high sensitivity to high-energy laser radiation. The extent to which the known recording layers possess those properties is unsatisfactory.

U.S. Pat. No. 5,821,621 discloses high-capacity storage media having a recording layer that consists substantially of one or more xanthene dyes. The nitrogen atoms may be free or may have been bound in any desired rings; in Example B1, the compound of formula 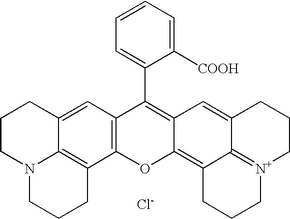
is used.

JP-A-2000/118145 discloses storage media suitable for recording with a laser having a wavelength of 635 nm, those media comprising xanthenes having a heterocyclic ring which include the compound of formula

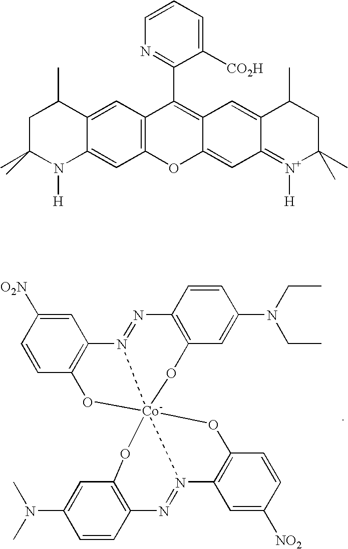

It has been found, however, that the properties of the known xanthene recording media still leave something to be desired, especially in terms of light stability and the quality of recordings using a laser having a wavelength of about 658 nm.

EP 0 567 622 B1 and U.S. Pat. No. 6,080,852 disclose pentacyclic xanthene compounds containing halogenated substituents, and their use as absorption dyes or fluorescent dyes in diagnostic systems. There is no mention therein, however, of either optical storage media or any other solid-state applications.

The aim of the invention was to provide an optical recording medium, the recording layer of which has high storage capacity combined with excellent other properties. The recording medium should be both writable and readable at the same wavelength in the range from 600 to 700 nm (preferably from 630 to 690 nm). The main features of the recording layer according to the invention are the very high initial reflectivity in the mentioned wavelength range of the laser diodes, which can be modified with high sensitivity, the high refractive index, the narrow absorption bands in the solid state, the good uniformity of script width at different-length pulse durations, the excellent light stability, the good solubility in polar solvents, and excellent compatibility with laser sources of various wavelengths for both recording and playback.

Very surprisingly, by the use of certain xanthene dyes as recording layer it has been possible to provide an optical recording medium having properties that are astonishingly better than those of the recording media known hitherto.

The invention accordingly relates to an optical recording medium comprising a substrate, a reflecting layer and a recording layer, wherein the recording layer comprises a compound of formula 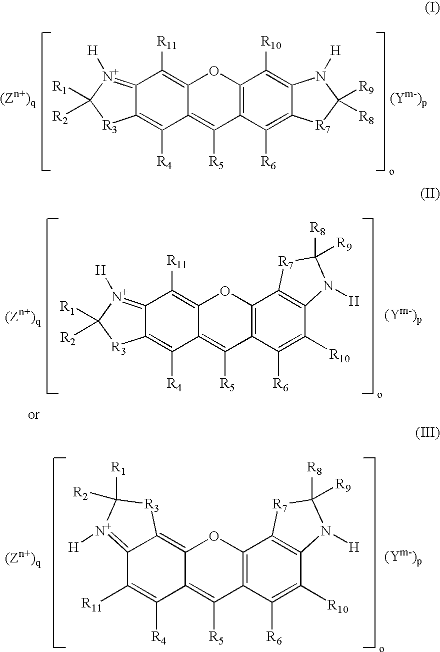
wherein R₁, R₂, R₈ and R₉ are each independently of the others C₁-C₁₂alkyl unsubstituted or mono- or poly-substituted by halogen, OR₁₂, SR₁₂, NO₂, CN, NR₁₃R₁₄, COOR₁₅, SO₃⁻, SO₃H or by SO₃R₁₂,
wherein R₁ and R₂ and/or R₈ and R₉ may be bonded to one another in pairs, via a direct bond or a bridge —O—, —S— or —NR₁₆—, in such a manner that a 5- to 12-membered ring is formed;
R₃ and R₇ are each independently of the other(s) C₁-C₃alkylene or C₂-C₃alkenylene each unsubstituted or mono- or poly-substituted by halogen, R₁₆, OR₁₆, SR₁₆, NO₂, CN, NR₁₇R₁₈, COOR₁₆, SO₃⁻, SO₃H or by SO₃R₁₆;
R₄, R₆, R₁₀ and R₁₁ are each independently of the others hydrogen, halogen, OR₁₉, SR₁₉, NO₂, NR₁₉R₂₀; or C₁-C₂₄alkyl, C₂-C₂₄alkenyl, C₂-C₂₄alkynyl, C₃-C₂₄cycloalkyl, C₃-C₂₄cycloalkenyl or C₇-C₁₈aralkyl each unsubstituted or mono- or poly-substituted by halogen, OR₁₉, SR₁₉, NO₂, CN or by NR₁₉R₂₀;
R₅ is hydrogen; (CH₂)ₖCOOR₂₁, C₁-C₂₄alkyl, C₂-C₂₄alkenyl, C₂-C₂₄alkynyl, C₃-C₂₄cycloalkyl or C₃-C₂₄cycloalkenyl each unsubstituted or mono- or poly-substituted by halogen, NR₂₁R₂₂ or by OR₂₂; or C₇-C₁₈aralkyl or C₆-C₁₄aryl each unsubstituted or mono- or poly-substituted by halogen, NO₂, CN, NR₂₁R₂₁, SO₃⁻, SO₃R₂₁, SO₂NR₂₁R₂₂, (CH₂)ₖOR₂₁, (CH₂)ₖOCOR₂₁, COOR₂₁, CONR₂₁R₂₂, OR₂₁, SR₂₁, PO₃⁻, PO(OR₂₁)(OR₂₂) or by SiR₁₅R₂₃R₂₄;
R₁₂, R₁₃, R₁₄, R₁₆, R₁₇, R₁₈, R₁₉, R₂₀, R₂₁ and R₂₂ are each independently of the others hydrogen; C₁-C₂₄alkyl, C₂-C₂₄alkenyl, C₂-C₂₄alkynyl, C₃-C₂₄cycloalkyl, C₃-C₂₄cycloalkenyl or C₃-C₁₂heterocycloalkyl each unsubstituted or mono- or poly-substituted by halogen, NO₂, CN, NR₁₅R₂₃, NR₁₅R₂₃R₂₄⁺, NR₁₅COR₂₃, NR₁₅CONR₂₃R₂₄, OR₁₅, SR₁₅, COOR₁₅, CHO, CR₁₅OR₂₃OR₂₄, COR₁₅, SO₂R₁₅, SO₃⁻, SO₃H, SO₃R₁₅ or by OSiR₁₅R₂₃R₂₄; or C₇-C₁₈aralkyl, C₆-C₁₄aryl or C₅-C₁₃heteroaryl each unsubstituted or mono- or poly-substituted by halogen, NO₂, CN, NR₁₅R₂₃, NR₁₅R₂₃R₂₄⁺, NR₁₅COR₂₃, NR₁₅CONR₂₃R₂₄, R₁₅, OR₁₅, SR₁₅, CHO, CR₁₅OR₂₃OR₂₄, COR₁₅, SO₂R₁₅, SO₃⁻, SO₂NR₁₅R₂₃, COOR₂₄, CONR₁₅R₂₃, PO₃⁻, PO(OR₁₅)(OR₂₃), SiR₁₅R₂₃R₂₄, OSiR₁₅R₂₃R₂₄or by SiOR₁₅OR₂₃OR₂₄,
or NR₁₃R₁₄, NR₁₇R₁₈, NR₁₉R₂₀ or NR₂₁R₂₂ is a five- or six-membered heterocycle which may contain an additional N or O atom and may be mono- or poly-substituted by C₁-C₈alkyl;
R₁₅, R₂₃ and R₂₄ are each independently of the others hydrogen, C₁-C₂₀alkyl, C₂-C₂₀alkenyl, C₂-C₂₀alkynyl or C₇-C₁₈aralkyl, wherein R₁₅ and R₂₃ may be bonded to one another, via a direct bond or a bridge —O—, —S— or —NC₁—C₈alkyl-, in such a manner that a five- or six-membered ring is formed;
wherein optionally from 1 to 4 radicals selected from the group consisting of R₁, R₂, R₃, R₄, R₅, R₆, R₇, R₈, R₉, R₁₀, R₁₁, R₁₂, R₁₃, R₁₄, R₁₅, R₁₆, R₁₇, R₁₈, R₁₉, R₂₀, R₂₁, R₂₂, R₂₃ and R₂₄ can be bonded to one another in pairs, via a direct bond or a bridge —O—, —S— or —N(G)-, or separately to Y^{m-} and/or to Zⁿ⁺, G being mono- or poly-substituted C₁-C₂₄alkyl, C₂-C₂₄alkenyl, C₂-C₂₄alkynyl, C₃-C₂₄cycloalkyl, C₃-C₂₄cycloalkenyl, C₃-C₁₂heterocycloalkyl, C₇-C₁₈aralkyl, C₆-C₁₄aryl or C₅-C₁₃heteroaryl;
Y^{m-} is an inorganic, organic or organometallic anion, or a mixture thereof;
Zⁿ⁺ is a proton or a metal, ammonium or phosphonium cation, or a mixture thereof;
k is an integer from 1 to 10;
m, n and o are each independently of the others an integer from 1 to 3; and
p and q are each a number from 0 to 4, the ratio of o, p and q to one another, depending on the charge of the associated sub-structures, being such that there is no excess positive or negative charge in formula (I), (II) or (III).

When the numbers p and q are not whole numbers, formula (I), (II) or (III) is to be understood as being a mixture of certain molar composition, the individual components of which may also be of different stoichiometry.

Anions of inorganic or organic acids are, for example, fluoride, chloride, bromide, iodide, perchlorate, periodate, carbonate, hydrogen carbonate, sulfate, hydrogen sulfate, phosphate, hydrogen phosphate, dihydrogen phosphate, tetrafluoroborate, hexafluoroantimonate, acetate, oxalate, methanesulfonate, trifluoromethanesulfonate, tosylate, methylsulfate, phenolate, benzoate or a negatively charged metal complex.

Metal, ammonium or phosphonium cations are, for example, Li⁺, Na⁺, K⁺, Mg²⁺, Ca²⁺, Cu²⁺, Ni²⁺, Fe²⁺, Co²⁺, Zn²⁺, Sn²⁺, Cr³⁺, La³⁺, methylammonium, ethylammonium, pentadecylammonium, isopropylammonium, dicyclohexylammonium, tetramethylammonium, tetraethylammonium, tetrabutylammonium, benzyltrimethylammonium, benzyltriethylammonium, methyltrioctylammonium, tridodecylmethylammonium, tetrabutylphosphonium, tetraphenylphosphonium, butyltriphenylphosphonium or ethyltriphenylphosphonium, or also protonated Primen 81R™ or Rosin Amin D™.

Alkyl, alkenyl or alkynyl may be straight-chain or branched. Alkenyl is alkyl that is mono- or poly-unsaturated, wherein two or more double bonds may be isolated or conjugated. Alkynyl is alkyl or alkenyl that is doubly-unsaturated one or more times, wherein the triple bonds may be isolated or conjugated with one another or with double bonds. Cycloalkyl or cycloalkenyl is monocyclic or polycyclic alkyl or alkenyl, respectively.

C₁-C₂₄Alkyl can therefore be, for example, methyl, ethyl, n-propyl, isopropyl, n-butyl, sec-butyl, isobutyl, tert-butyl, 2-methyl-butyl, n-pentyl, 2-pentyl, 3-pentyl, 2,2-dimethylpropyl, n-hexyl, heptyl, n-octyl, 1,1,3,3-tetramethylbutyl, 2-ethylhexyl, nonyl, decyl, undecyl, dodecyl, tridecyl, tetradecyl, pentadecyl, hexadecyl, heptadecyl, octadecyl, nonadecyl, eicosyl, heneicosyl, docosyl or tetracosyl.

C₃-C₂₄Cycloalkyl can therefore be, for example, cyclopropyl, cyclopropyl-methyl, cyclobutyl, cyclopentyl, cyclohexyl, cyclohexyl-methyl, trimethylcyclohexyl, thujyl, norbornyl, bornyl, norcaryl, caryl, menthyl, norpinyl, pinyl, 1-adamantyl, 2-adamantyl, 5α-gonyl or 5ξ-pregnyl.

C₂-C₂₄Alkenyl is, for example, vinyl, allyl, 2-propen-2-yl, 2-buten-1-yl, 3-buten-1-yl, 1,3-butadien-2-yl, 2-penten-1-yl, 3-penten-2-yl, 2-methyl-1-buten-3-yl, 2-methyl-3-buten-2-yl, 3-methyl-2-buten-1-yl, 1,4-pentadien-3-yl, or any desired isomer of hexenyl, octenyl, nonenyl, decenyl, dodecenyl, tetradecenyl, hexadecenyl, octadecenyl, eicosenyl, heneicosenyl, docosenyl, tetracosenyl, hexadienyl, octadienyl, nonadienyl, decadienyl, dodecadienyl, tetradecadienyl, hexadecadienyl, octadecadienyl or eicosadienyl.

C₃-C₂₄Cycloalkenyl is, for example, 2-cyclobuten-1-yl, 2-cyclopenten-1-yl, 2-cyclohexen-1-yl, 3-cyclohexen-1-yl, 2,4-cyclohexadien-1-yl, 1-p-menthen-8-yl, 4(10)-thujen-10-yl, 2-norbornen-1-yl, 2,5-norbornadien-1-yl, 7,7-dimethyl-2,4-norcaradien-3-yl or camphenyl.

C₂-C₁₄Alkynyl is, for example, 1-propyn-3-yl, 1-butyn-4-yl, 1-pentyn-5-yl, 2-methyl-3-butyn-2-yl, 1,4-pentadiyn-3-yl, 1,3-pentadiyn-5-yl, 1-hexyn-6-yl, cis-3-methyl-2-penten-4-yn-1-yl, trans-3-methyl-2-penten-4-yn-1-yl, 1,3-hexadiyn-5-yl, 1-octyn-8-yl, 1-nonyn-9-yl, 1-decyn-10-yl or 1-tetracosyn-24-yl.

C₇-C₂₄Aralkyl is, for example, benzyl, 2-benzyl-2-propyl, β-phenyl-ethyl, 9-fluorenyl, oco-dimethylbenzyl, ω-phenyl-butyl, ω-phenyl-octyl, ω-phenyl-dodecyl or 3-methyl-5-(1′,1′,3′,3′-tetramethyl-butyl)-benzyl. C₇-C₂₄Aralkyl can also be, for example, 2,4,6-tri-tert-butyl-benzyl or 1-(3,5-dibenzyl-phenyl)-3-methyl-2-propyl. When C₇-C₂₄aralkyl is substituted, either the alkyl moiety or the aryl moiety of the aralkyl group can be substituted, the latter alternative being preferred.

C₆-C₂₄Aryl is, for example, phenyl, naphthyl, biphenylyl, 2-fluorenyl, phenanthryl, anthracenyl or terphenylyl.

Halogen is chlorine, bromine, fluorine or iodine, preferably chlorine or bromine.

C₄-C₁₂Heteroaryl is an unsaturated or aromatic radical having 4n+2 conjugated π-electrons, for example 2-thienyl, 2-furyl, 1-pyrazolyl, 2-pyridyl, 2-thiazolyl, 2-oxazolyl, 2-imidazolyl, isothiazolyl, triazolyl or any other ring system consisting of thiophene, furan, pyridine, thiazole, oxazole, imidazole, isothiazole, thiadiazole, triazole, pyridine and benzene rings and unsubstituted or substituted by from 1 to 6 ethyl, methyl, ethylene and/or methylene substituents.

Furthermore, aryl and aralkyl can also be aromatic groups bonded to a metal, for example in the form of metallocenes of transition metals known per se, more especially 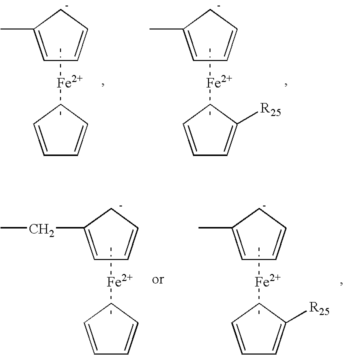
wherein R₂₅ is CH₂OH, CH₂OR₁₆ or COOR₁₆.

C₃-C₁₂Heterocycloalkyl is an unsaturated or partially unsaturated ring system radical, for example an epoxide, oxetane, aziridine; tetrazolyl, pyrrolidyl, piperidyl, piperazinyl, imidazolinyl, pyrazolidinyl, pyrazolinyl, morpholinyl, quinuclidinyl; or another C₄-C₁₂heteroaryl that is mono- or poly-hydrogenated.

5- to 1 2-membered rings are, for example, cyclopentyl, cyclohexyl, cycloheptyl or cyclooctyl, preferably cyclopentyl and especially cyclohexyl.

As R₁ to R₂₂, the following substituents, especially, may be mentioned: —CH₂—CH₂—OH, —CH₂—O—CH₃, —CH₂—O—(CH₂)₇—CH₃, —CH₂—CH₂—O—CH₂—CH₃, —CH₂—CH(OCH₃)₂, —CH₂—CH₂—CH(OCH₃)₂, —CH₂—C(OCH₃)₂—CH₃, —CH₂—CH₂—O—CH₂—CH₂—O—CH₃, —(CH₂)₃—OH, —(CH₂)₆—OH, —(CH₂)₇—OH, —(CH₂)₈—OH, —(CH₂)₉—OH, —(CH₂)₁₀—OH, —(CH₂)₁₁—OH, —(CH₂)₁₂—OH, —CH₂—Si(CH₃)₃, —CH₂—CH₂—O—Si(CH₃)₂—C(CH₃)₃, —(CH₂)₃—O—Si(CH₃)₂—C(CH₃)₃, —(CH₂)₄—O—Si(C₆H₅)₂—C(CH₃)₃, —(CH₂)₅—O—Si(CH(CH₃)₂)₃, —CH₂—CH₂—CH(CH₃)—CH₂—CH₂—CH(OH)—C(CH₃)₂—OH, —CH₂—CH(CH₃)—CH₂—OH, —CH₂—C(CH₃)₂—CH₂—OH, —CH₂—C(CH₂—OH)₃, —CH₂—CH(OH)—CH₃, —CH₂—CH(OH)—CH₂—OH, 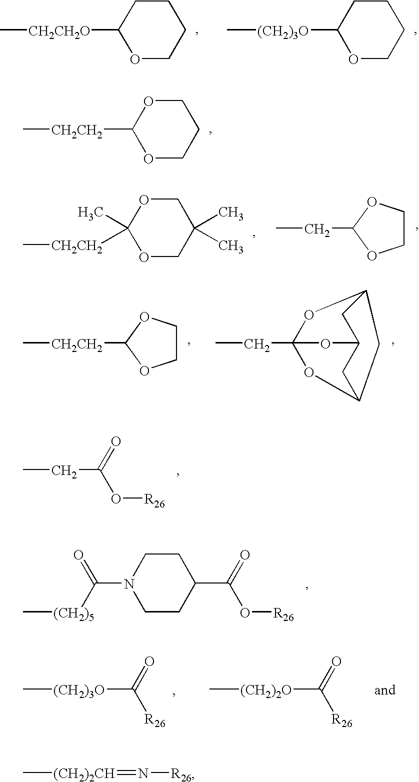
wherein R₂₆ is C₁-C₂₄alkyl, C₂-C₂₄alkenyl, C₂-C₂₄alkynyl, C₃-C₂₄cycloalkyl, C₃-C₂₄cycloalkenyl, C₇-C₂₄aralkyl, C₆-C₂₄aryl, C₄-C₁₂heteroaryl or C₃-C₁₂heterocycloalkyl each unsubstituted or substituted by one or more identical or different radicals according to the definitions given above, or is a metal complex. When R₂₇ is C₁-C₂₄alkyl, that radical may be uninterrupted or interrupted by from 1 to 3 oxygen and/or silicon atoms. Of special advantage is alkyl that is unsubstituted or substituted by one or two hydroxy substituents or by a metallocenyl or azo metal complex radical, especially methyl, ethyl, n-propyl, isopropyl, n-butyl, 2-butyl, isobutyl, tert-butyl, n-amyl, 3-pentyl, tert-amyl, neopentyl, 2,2-dimethyl-but-4-yl, 2,2,4-trimethyl-pent-5-yl, cyclopropyl, cyclopropylmethyl, cyclobutyl, cyclobutylmethyl, cyclopentyl, cyclopentylmethyl, cyclohexyl, cyclohexylmethyl, cyclohex-4-enyl-methyl, 5-methyl-cyclohex-4-enyl-methyl or 2-ethyl-hexyl. Those radicals as R₅ are of very special importance.

The recording medium according to the invention, besides comprising a compound of formula (I), (II) or (III), may additionally comprise salts, for example ammonium chloride, pentadecylammonium chloride, sodium chloride, sodium sulfate, sodium methyl sulfonate or sodium methyl sulfate, the ions of which may originate e.g. from the components used.

Preference is given to compounds of formula (I), (II) or (In) wherein R₁, R₂, R₈ and R₉ are each independently of the others unsubstituted or fluorine-substituted C₁-C₄alkyl, or R₁ and R₂ and/or R₈ and R₉ together form a 5- or 6-membered ring;

R₃ and R₇ are each independently of the other(s) 1,2-ethylene or 1,2-ethenylene each unsubstituted or substituted by R₁₆;
R₄, R₆, R₁₀ and R₁₁ are each independently of the others hydrogen, halogen, NO₂, OR₁₉ or unsubstituted C₁-C₂₀alkyl, C₂-C₂₀alkenyl, C₂-C₂₀alkynyl, C₃-C₂₀cycloalkyl, C₃-C₂₀cycloalkenyl, C₃-C₂₀heterocycloalkyl or C₇-C₁₈aralkyl;
R₅ is hydrogen, (CH₂)ₖCOOR₂₁, or phenyl, pyridyl, naphthyl or quinolyl each unsubstituted or mono- or poly-substituted by halogen, NO₂, NR₂₁R₂₂, SO₃R₂₁, SO₂NR₂₁R₂₂, (CH₂)ₖOR₂₁, COOR₂₁, CONR₂₁R₂₂ or by OR₂₁;
R₁₂, R₁₃, R₁₄, R₁₆, R₁₇, R₁₈, R₁₉, R₂₀, R₂₁ and R₂₂ are each independently of the others hydrogen or unsubstituted C₁-C₂₀alkyl, C₂-C₂₀alkenyl, C₂-C₂₀alkynyl or C₇-C₁₈aralkyl; and
o is an integer 1 or 2; or
Y^{m-} is a transition metal complex anion that contains at least one phenolic or phenylcarboxylic azo compound as ligand, m is an integer 1 or 2 and p is a number from 0 to 2; or
Z is a proton or a metal or ammonium cation, n is an integer 1 or 2 and q is a number from 0 to 1½, especially the number 0.

Special preference is given to compounds of formula (I), (II) or (III) wherein R₁, R₂, R₈ and R₉ are each independently of the others methyl, ethyl, n-propyl, isopropyl, n-butyl, 2-butyl, isobutyl, tert-butyl, n-amyl, 3-pentyl, tert-amyl, neopentyl, 2,2-dimethyl-but-4-yl, 2,2,4-trimethyl-pent-5-yl, cyclopropyl, cyclopropylmethyl, cyclobutyl, cyclobutylmethyl, cyclopentyl, cyclopentylmethyl, cyclohexyl, cyclohexylmethyl, cyclohex-4-enyl-methyl, 5-methyl-cyclohex-4-enyl-methyl or 2-ethyl-hexyl each unsubstituted or mono- or poly-substituted by fluorine;
R₃ and R₇ are each independently of the other(s) 1,2-ethylene or 1,2-ethenylene each unsubstituted or substituted by methyl, ethyl, n-propyl, isopropyl, n-butyl, 2-butyl, isobutyl, tert-butyl, n-amyl, 3-pentyl, tert-amyl, neopentyl, 2,2-dimethyl-but-4-yl, 2,2,4-trimethyl-pent-5-yl, cyclopropyl, cyclopropylmethyl, cyclobutyl, cyclobutylmethyl, cyclopentyl, cyclopentylmethyl, cyclohexyl, cyclohexylmethyl, cyclohex-4-enyl-methyl, 5-methyl-cyclohex-4-enyl-methyl or by 2-ethyl-hexyl, it being possible for R₃ and R₇ to be unsubstituted or mono- or poly-substituted by fluorine;
R₄ and R₆ are hydrogen;
R₅ is phenyl or naphthyl each unsubstituted or mono- or poly-substituted by halogen, NO₂, SO₃R₂₁, SO₂NR₂₁R₂₂, COOR₂₁ or by CONR₂₁R₂₂;
R₁₀, R₁₁, R₁₂, R₁₃, R₁₄, R₁₆, R₁₇, R₁₈, R₁₉, R₂₀, R₂₁ and R₂₂ are each independently of the others hydrogen, or methyl, ethyl, n-propyl, isopropyl, n-butyl, 2-butyl, isobutyl, tert-butyl, n-amyl, 3-pentyl, tert-amyl, neopentyl, 2,2-dimethyl-but-4-yl, 2,2,4-trimethyl-pent-5-yl, cyclopropyl, cyclopropylmethyl, cyclobutyl, cyclobutylmethyl, cyclopentyl, cyclopentylmethyl, cyclohexyl, cyclohexylmethyl, cyclohex-4-enyl-methyl, 5-methyl-cyclohex-4-enyl-methyl or 2-ethyl-hexyl each unsubstituted or mono- or poly-substituted by fluorine.

Those preferences apply to each of the sub-structures present in formula (I), (II) or (III), in each case independently of any other sub-structures which may be present, provided that the condition inherent in formula (I), (II) or (III) is fulfilled, i.e. that the resulting compound does not have an excess positive or negative charge. Sub-structures of formula (I), (II) or (III) are to be understood as being their three components [xanthene]₀, (Y^{m-})ₚ and (Zⁿ⁺)_{q}, which as indicated above may or may not be bonded to one another. As will be seen from the definition given above, the sub-structures may be bonded to one another, or a plurality of identical or different sub-structures may be present, for example in the form of dimers.

For example, compounds of formula (I), (II) or (III) may comprise the following sub-structures as xanthene moiety:

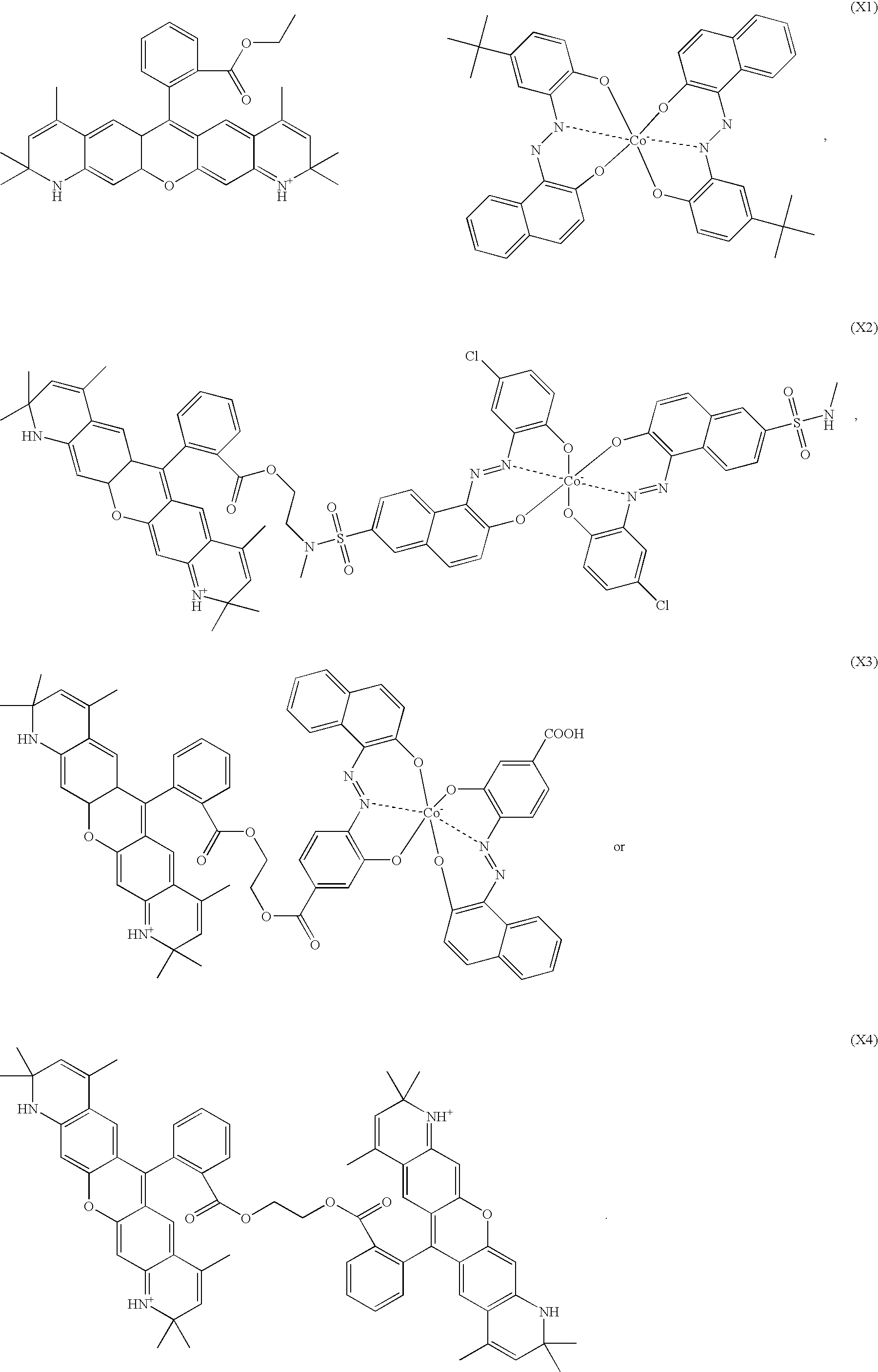

Further examples may be found in the preferences given below.

Preference is given, especially on account of their high level of light fastness, to compounds of formula (I), (II) or (III) wherein Y^{m-} is a transition metal complex anion. Special preference is given to the cations Zⁿ⁺ and especially anions Y^{m-} derived from the metal complexes disclosed in EP 0 822 544, EP 0 844 243, EP 0 903 733, EP 0 996 123, EP 1 056 078, EP 1 130 584 or U.S. Pat. No. 6,162,520 (wherein all transition metal complex structures disclosed in those patent applications listed by way of reference are to be considered as part of the invention), and also to transition metal complex anions Y^{m-} of formula
[(L₁)M₁(L₂)]^{m-} (IV)
or [(L₃)M₂(L₄)]⁻ (V),
wherein M₁ and M₂ are a transition metal, for example Ni²⁺, Co²⁺ or Cu²⁺, M₁ preferably being Cr³⁺ or Co³⁺ and M₂ preferably being Ni²⁺, Co²⁺ or Cu²⁺, m is a number from 1 to 6, L₁ and L₂ are each independently of the other(s) a ligand of formula 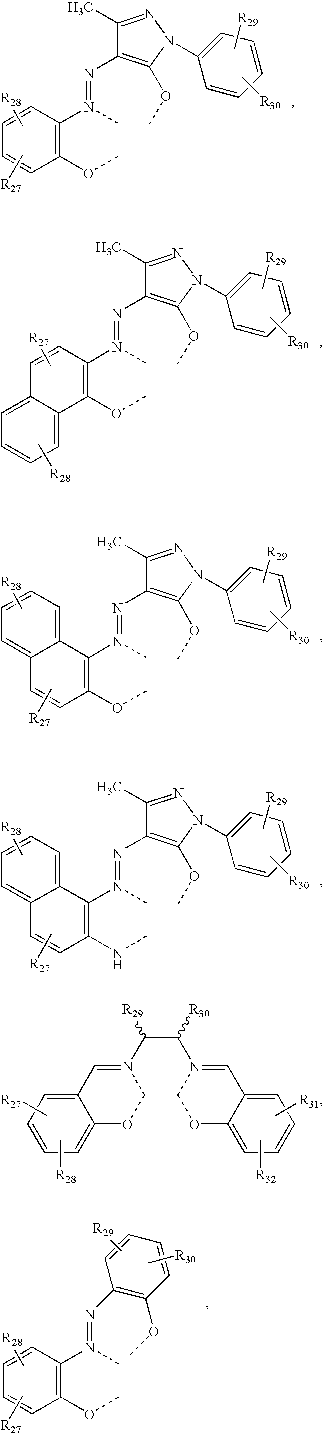 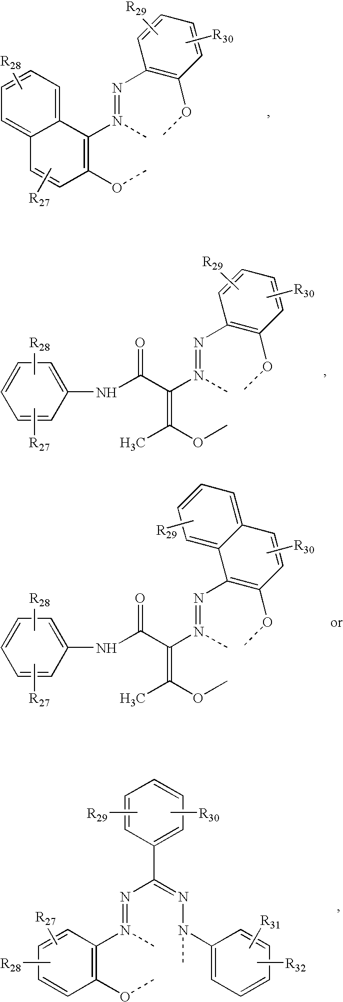
and L₃ and L₄ are each independently of the other a ligand of formula 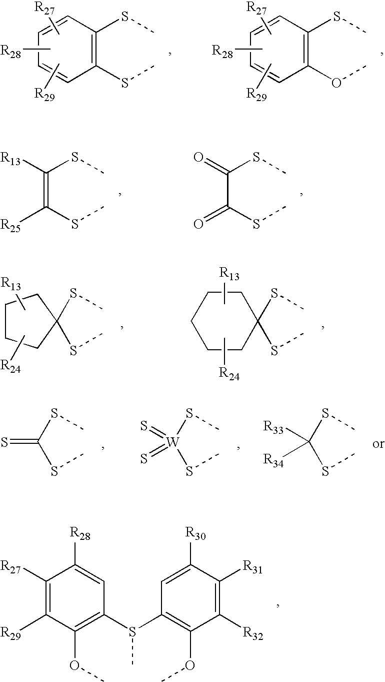
wherein R₂₇, R₂₈, R₂₉, R₃₀, R₃₁ and R₃₂ are each independently of the others hydrogen, halogen, cyano, R₃₅ N═N—R₃₆, 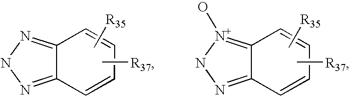
NO₂, OH, OR₃₅, SH, SR₃₅, NR₃₅R₃₈, NHCO—R₃₅, NHCOO—R₃₅, SO₂—R₃₅, SO₂NH₂, SO₂NH—R₃₅ or SO₂NR₃₅R₃₈, preferably hydrogen, chlorine, SO₂NH₂ or SO₂NHR₃₅, R₃₅ and R₃₄ are each independently of the other CN, CONH₂, CONHR₃₅, CONR₃₅R₃₈, COOR₃₅ or COR₃₅; R₃₅ and R₃₈ are each independently of the other unsubstituted or hydroxy-, halo-, sulfato-, C₁-C₆alkoxy-, C₁-C₆alkylthio-, C₁-C₆al kylamino- or di-C₁-C₆alkylamino-substituted C₁-C₁₂alkyl, C₁-C₁₂alkoxy-C₂-C₁₂alkyl, C₇-C₁₂aralkyl or C₆-C₁₂aryl, preferably C₁-C₄alkyl; R₃₆ is C₆-C₁₂aryl unsubstituted or substituted by hydroxy, halogen, sulfato, C₁-C₆alkoxy, C₁-C₆alkylthio, C₁-C₆alkylamino or by di-C₁-C₆alkylamino and R₃₇ is nitro, chlorine, SO₂NH₂, SO₂NHR₃₅, SO₂NR₃₅R₃₈, CN, CONH₂, CONHR₃₅, CONR₃₅R₃₈, COR₃₅ or R₃₅ and R₃₈ together are C₄-C₁₀heterocycloalkyl; it also being possible for R₂₈ and R₂₇, R₂₉ and R₃₀, and/or R₃₁ and R₃₂ in each case to be bonded to one another in pairs in such a manner that a 5- or 6-membered ring is formed; and for C₁-C₆alkoxy, C₁-C₆alkylthio, C₁-C₆alkylamino and/or di-C₁-C₆alkylamino to be unsubstituted or substituted by hydroxy or by C₁-C₄alkoxy.

Especially preferably, L₁ and/or L₂ have the formula 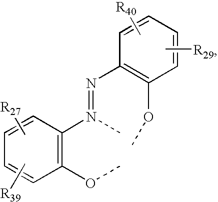
wherein R₃₉ is OH, OR₃₅, SR₃₅ or NR₃₅R₃₈ and R₄₀ is NO₂, CN, 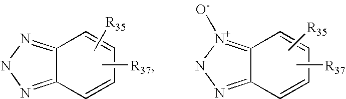
or N═N—R₃₆.

It will be understood that other transition metal complex ions can be used by the person skilled in the art, for example those which are known as dyes.

Special preference is given also especially to compounds of formula (I), (II) or (III) wherein m, n and o are each the number 1, p is a number from 0 to 2½, and q is 0, o being equal to p so that there is no excess positive or negative charge in formula (IV).

Very special preference is given to compounds of formula (I), (II) or (III) comprising the following sub-structures as xanthene moiety: 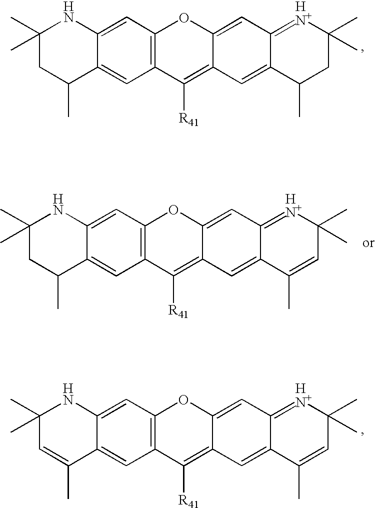
wherein in each of the 3 cases R₄₁ is 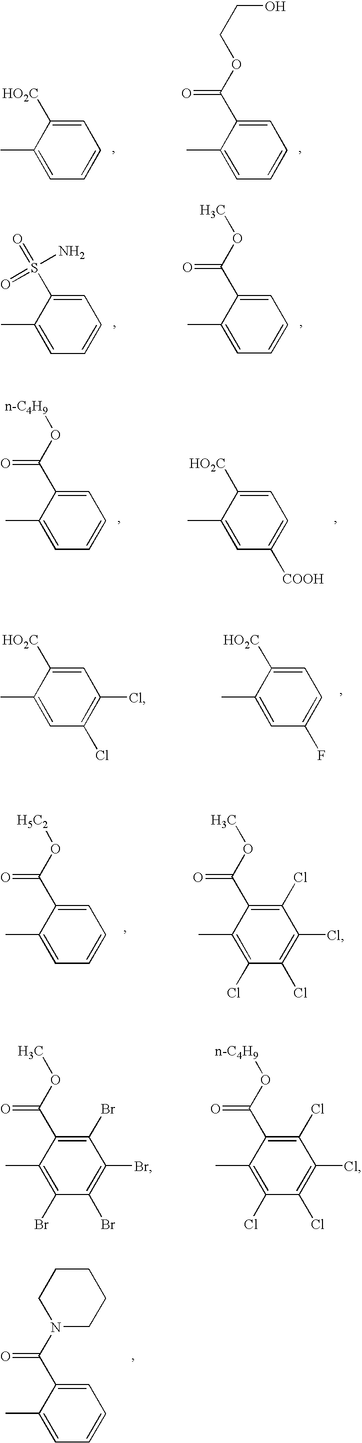 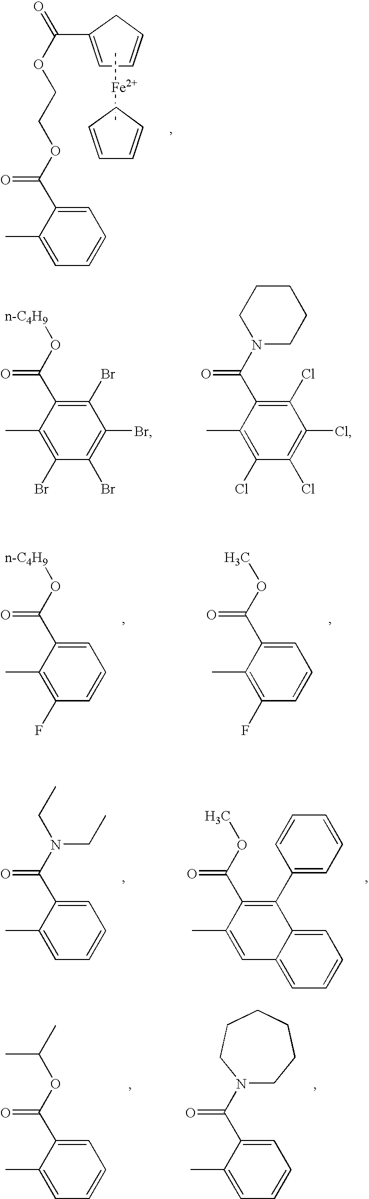 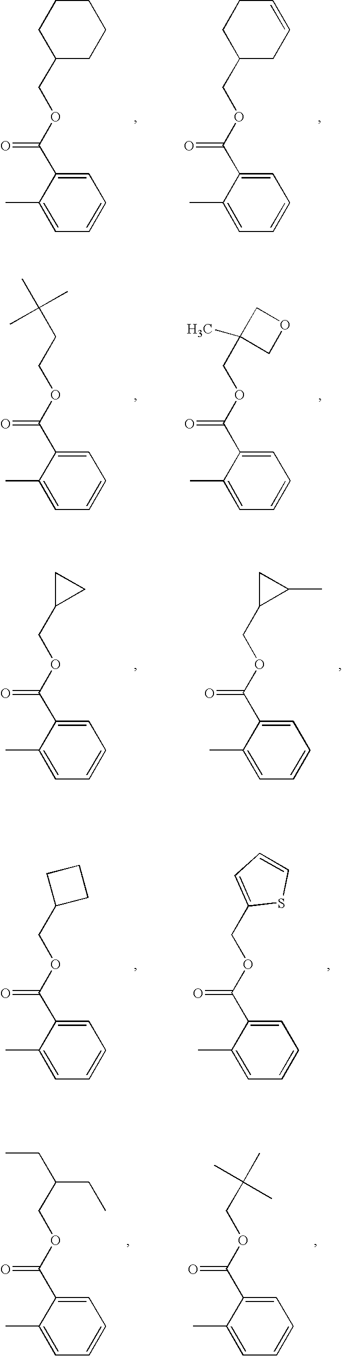 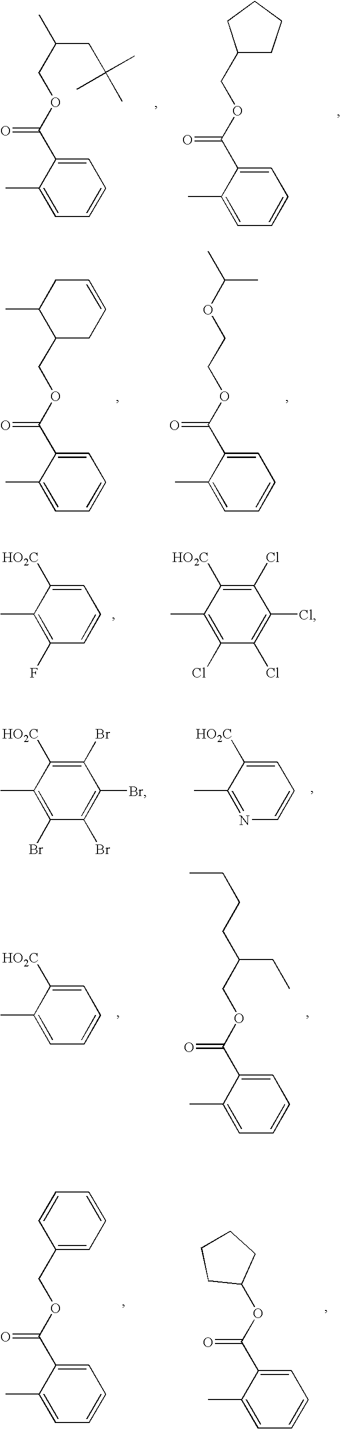 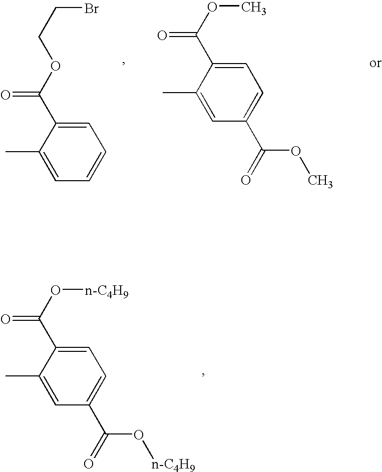
each especially preferably in combination with chloride, perchlorate or metal complex anions. Surprisingly, the perchlorate ions have proved especially suitable in the preparation of high-purity compounds of formula (I), (II) or (III), which have even better properties in optical recording media. Xanthenes according to the invention with perchlorate as counter-ion can advantageously be used both as compounds of formula (I), (II) or (III) themselves and as precursors thereto. In an especially preferred method of preparing compounds of formula (I), (II) or (III) wherein Y^{m-} is an organometallic anion, a compound of formula (I), (II) or (III) wherein Y^{m-} is perchlorate is reacted with the lithium, sodium, potassium or ammonium salt of an organometallic anion, and the desired compound thereafter isolated in highly pure form by surprisingly simple methods.

The invention accordingly relates also to the use of a compound of formula 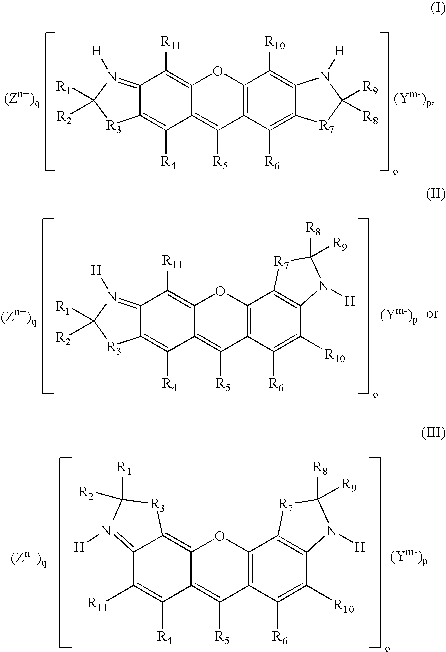
wherein Y^{m-} is perchlorate as starting material in the preparation of a compound of formula (I), (II) or (III) wherein Y^{m-} is an organometallic anion by addition of a compound of formula M₃⁺ Y^{m-} wherein M₃ is Li, Na, K or H₃NR₅. It will be understood that that method can also be used in the preparation of analogous compounds.

Very special preference is given likewise to the compounds of formula (I), (II) or (III), especially those having the above-mentioned xanthene sub-structures, that comprise as a sub-structure metal complex anions, for example:

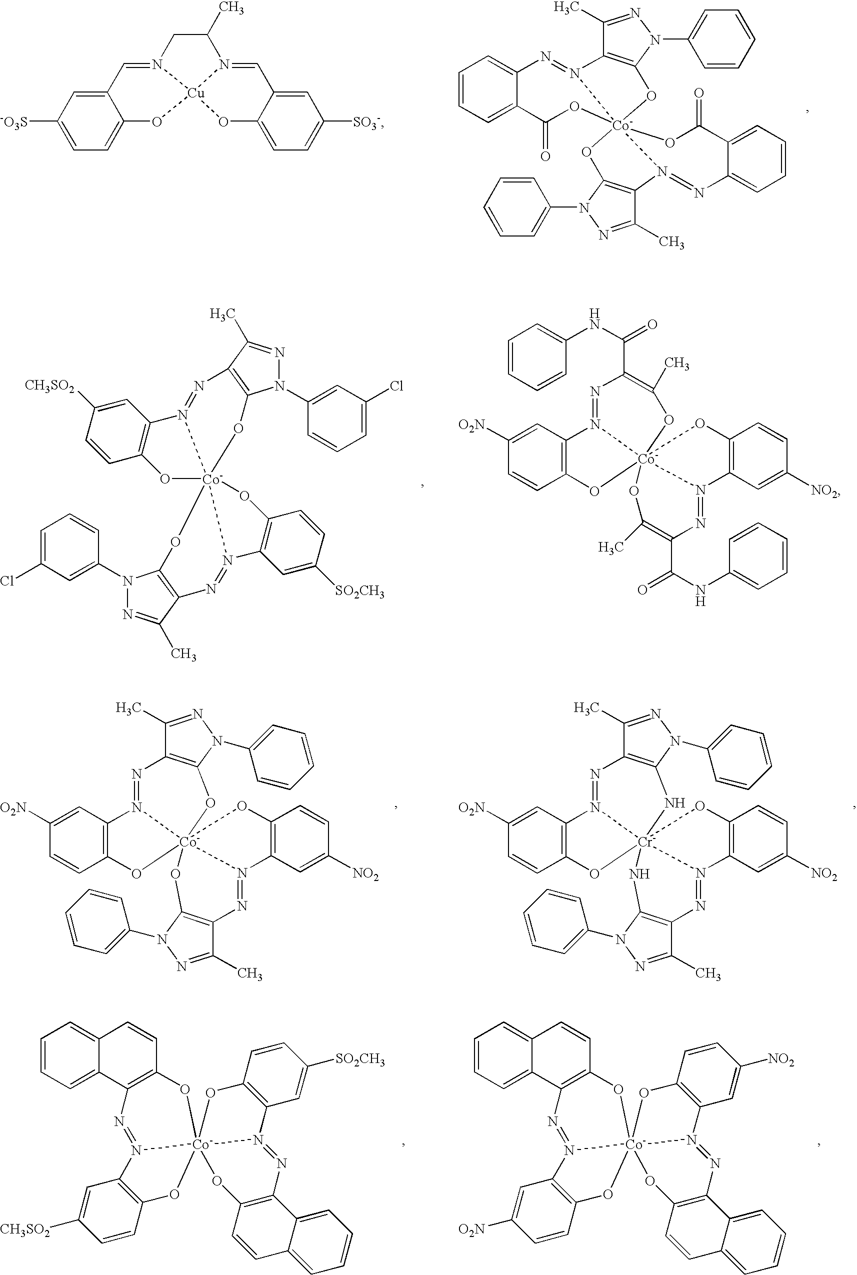

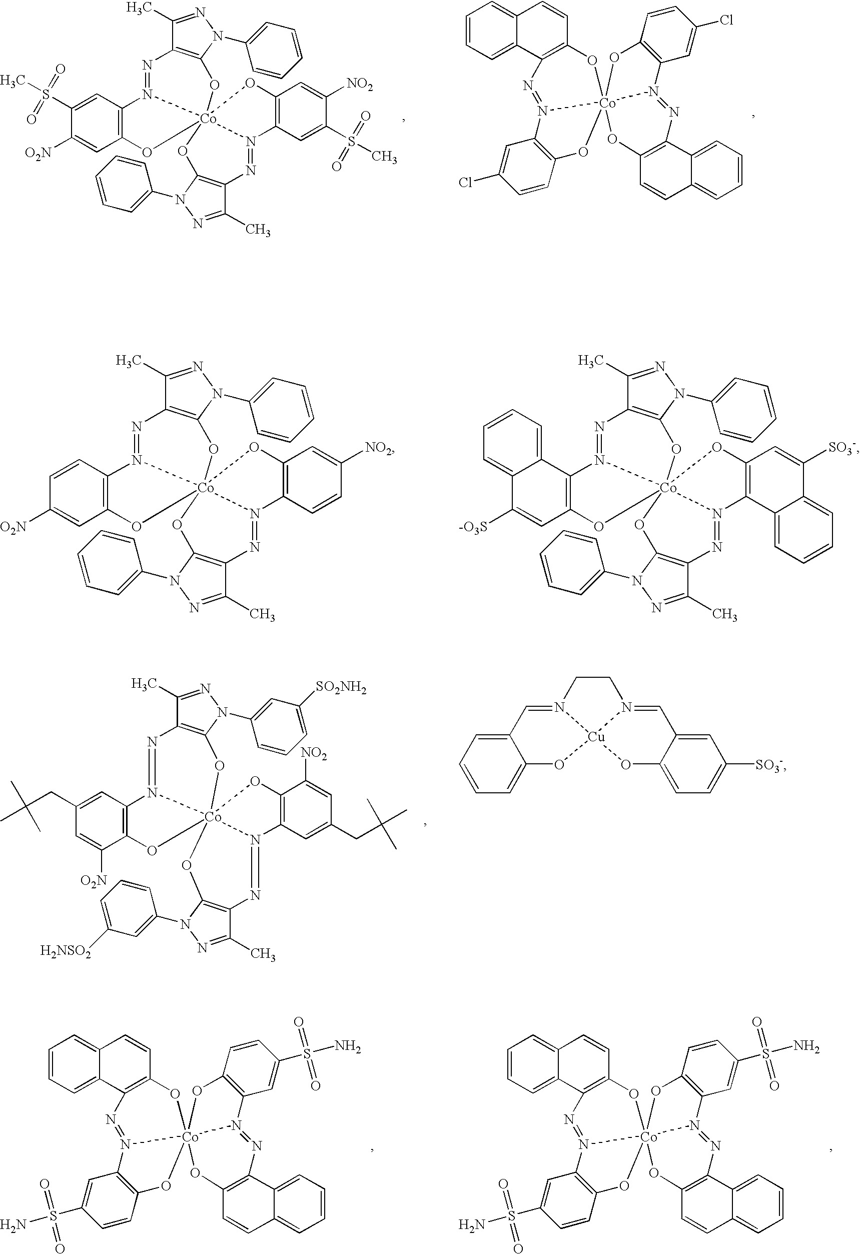

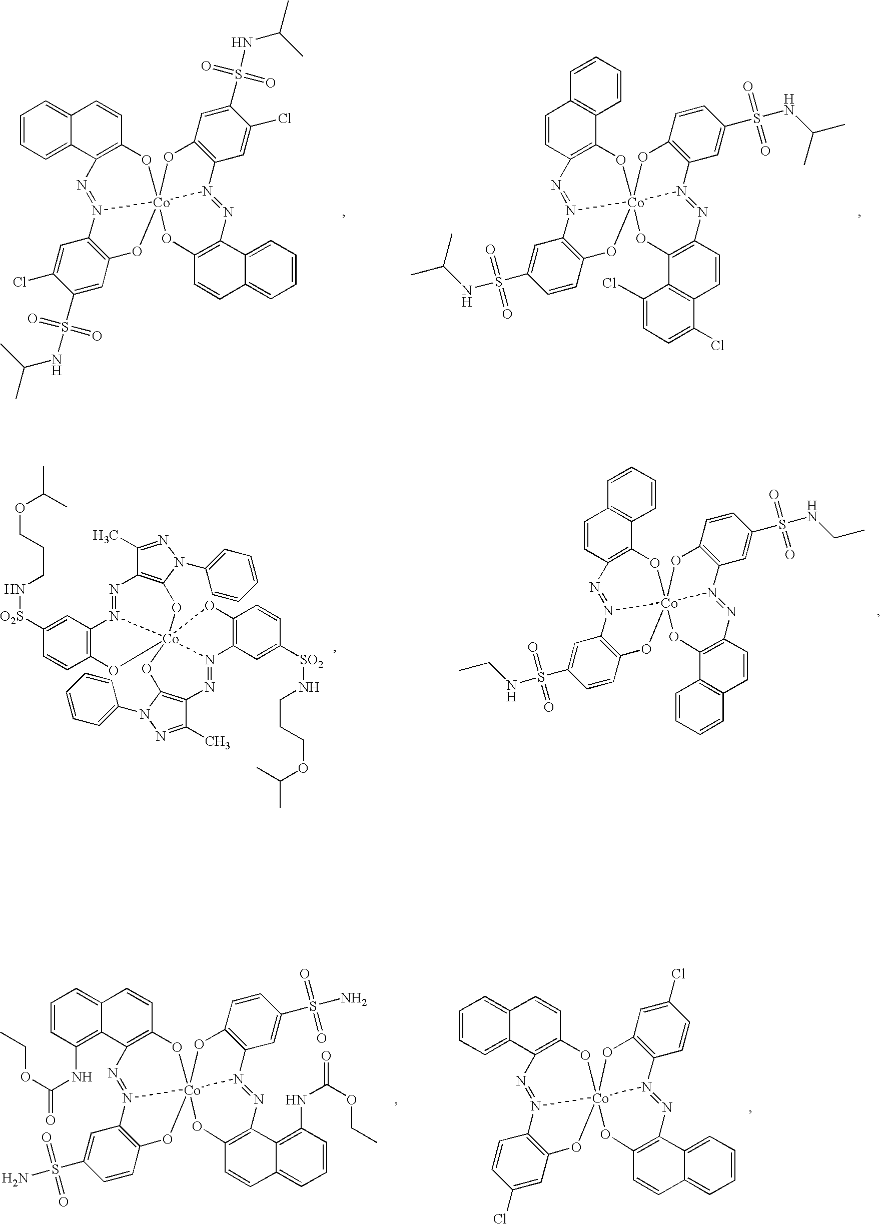

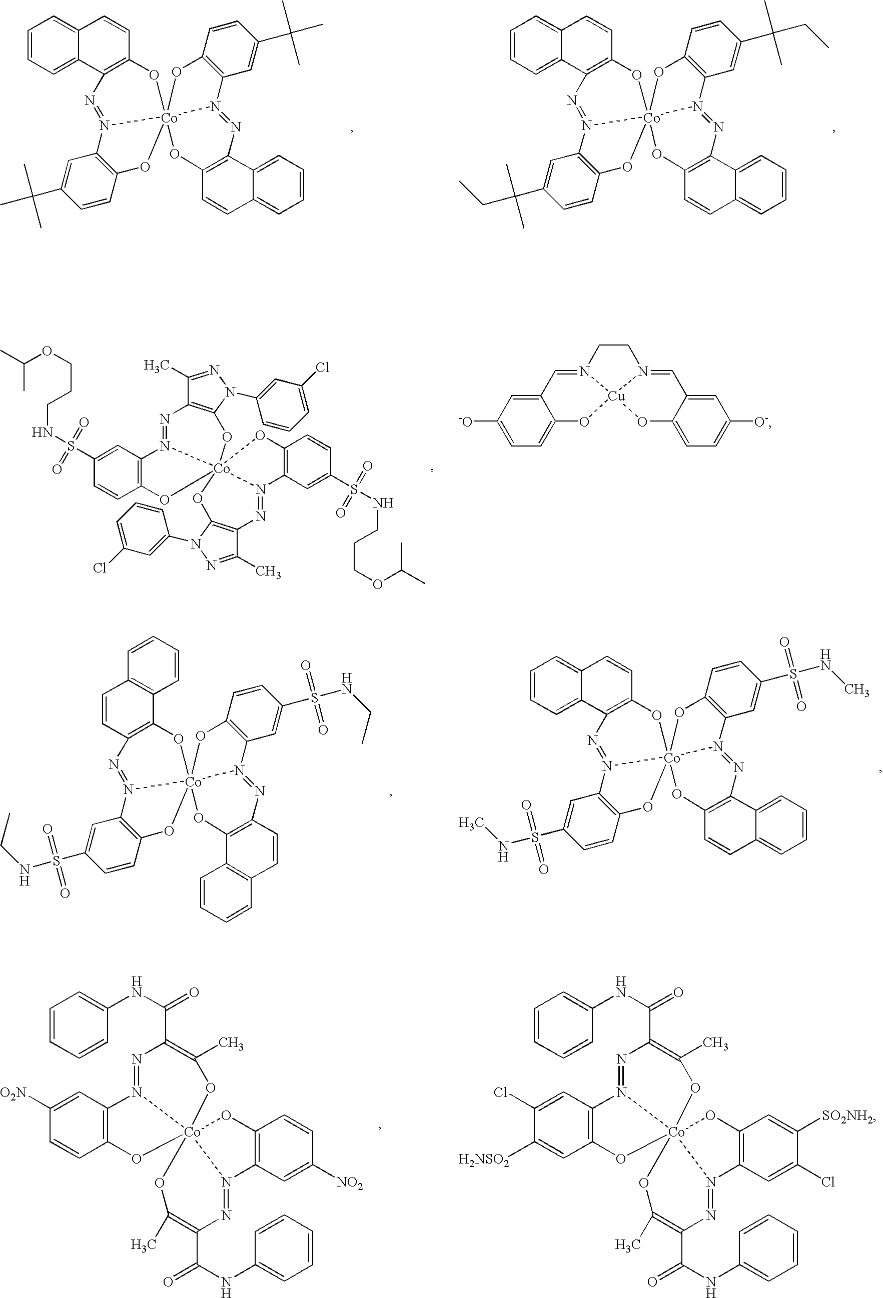

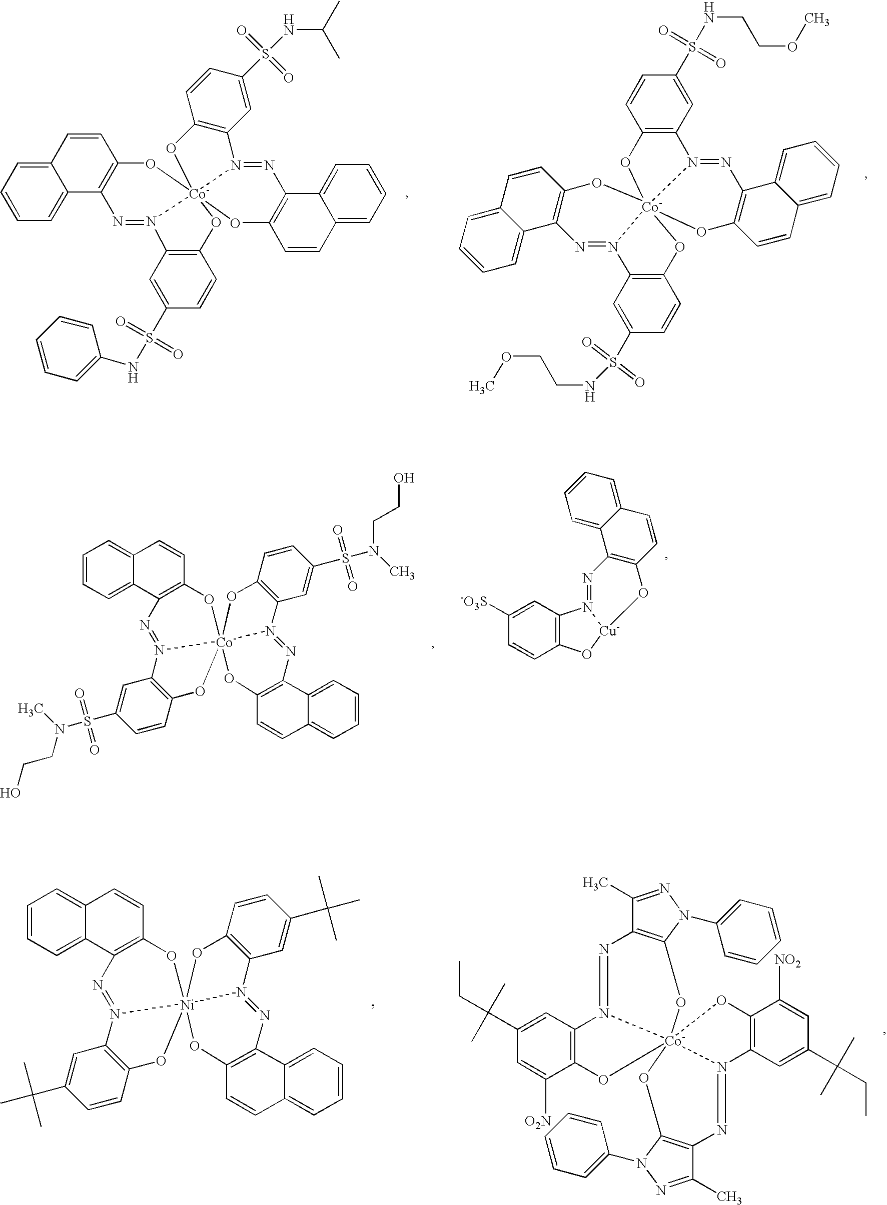

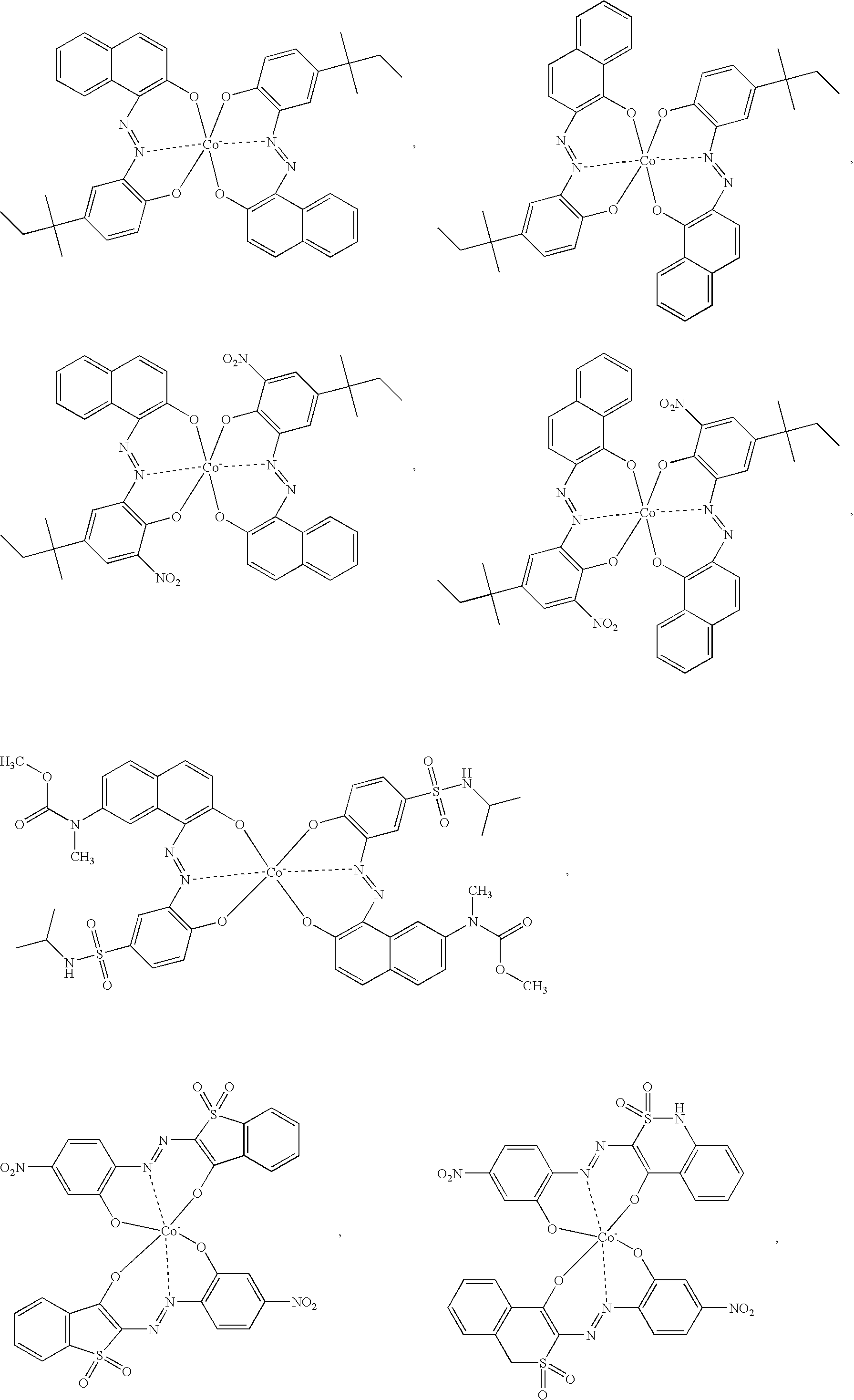

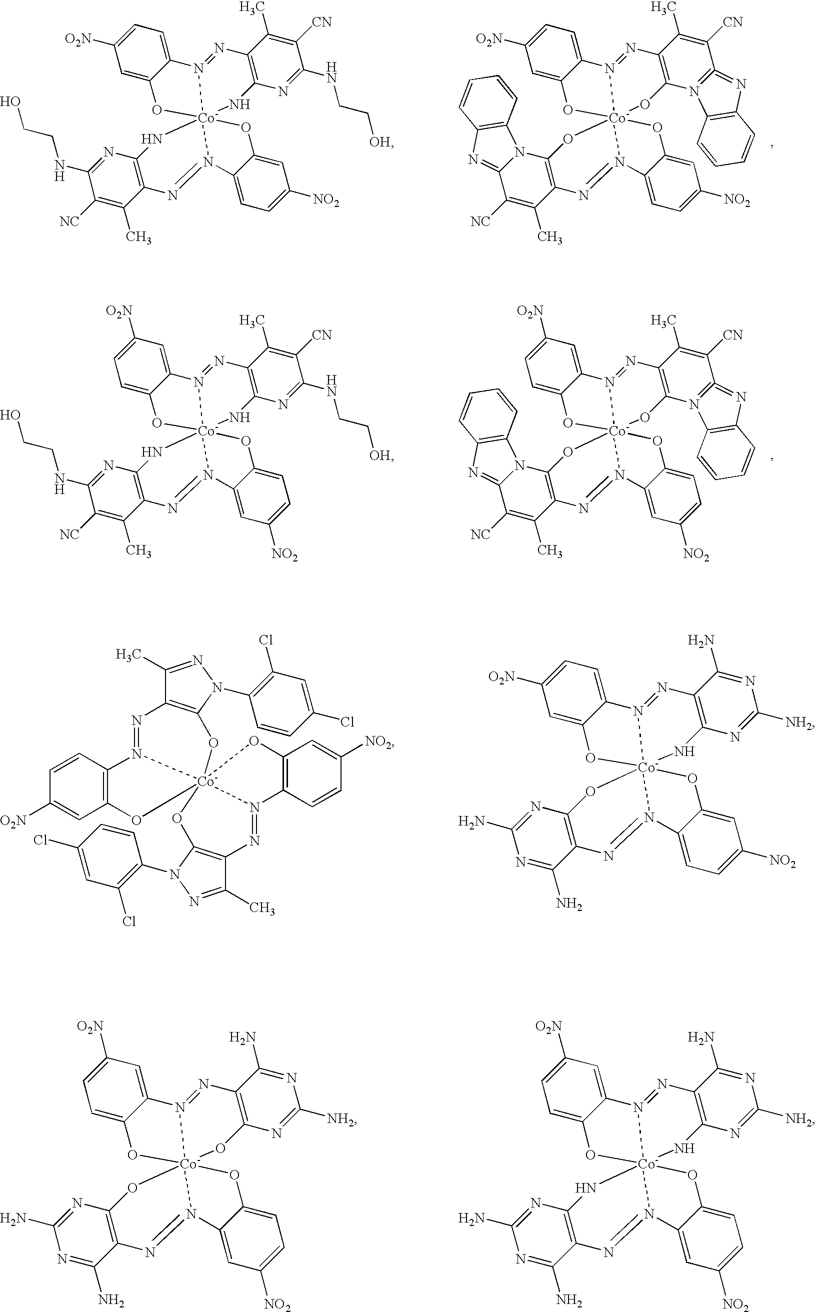

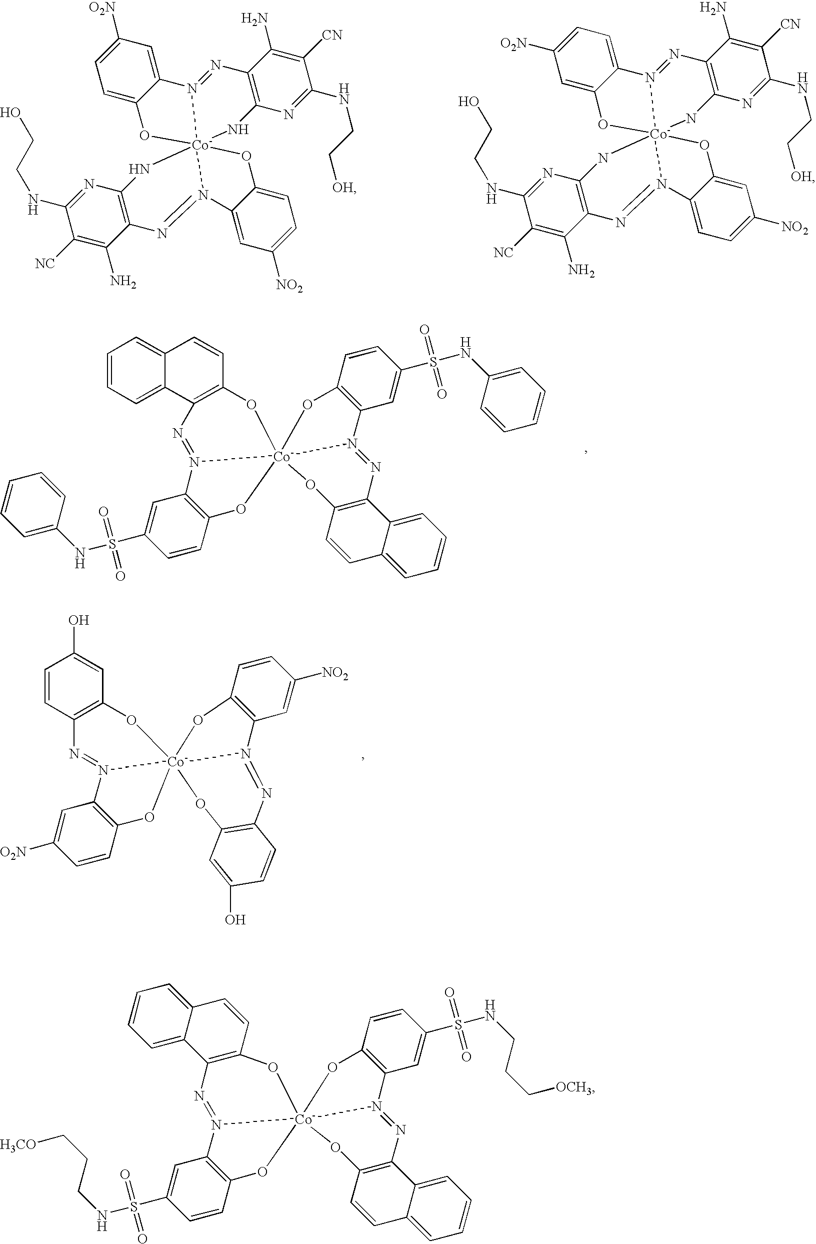

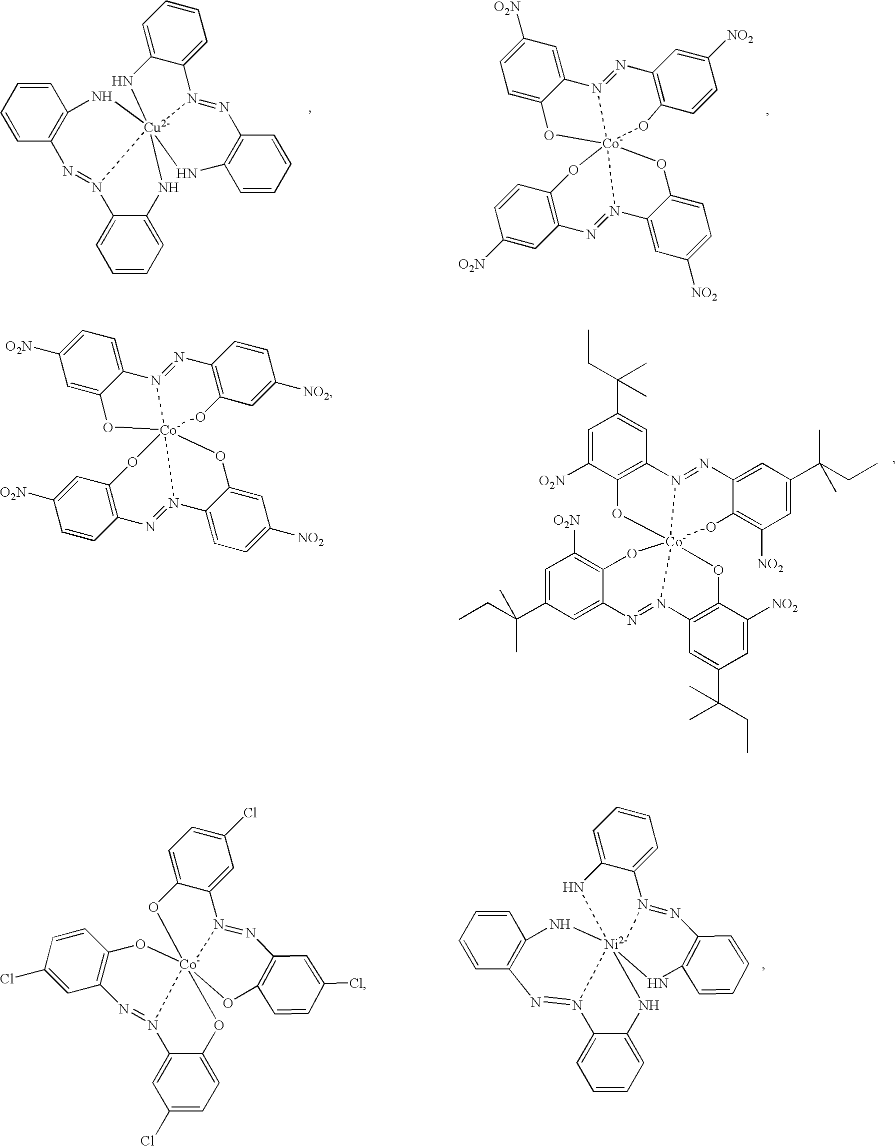

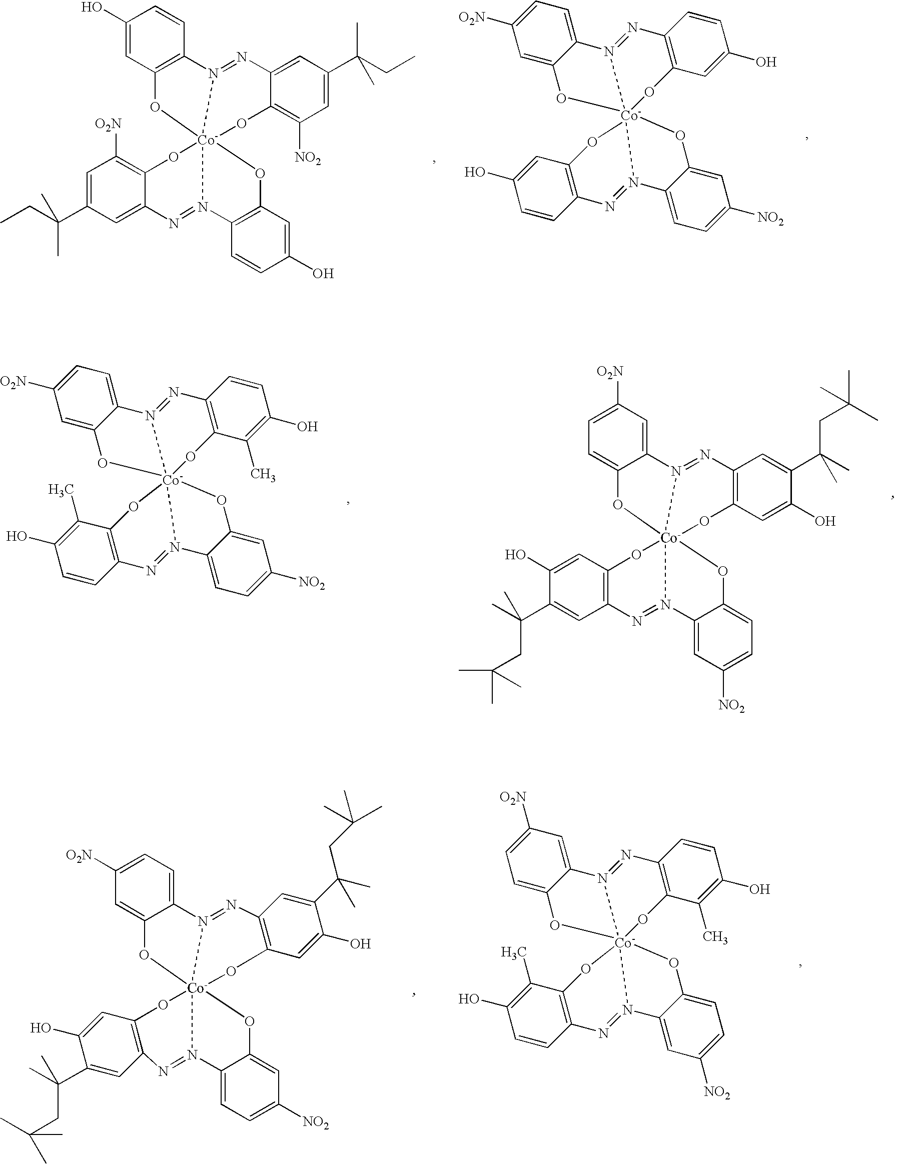

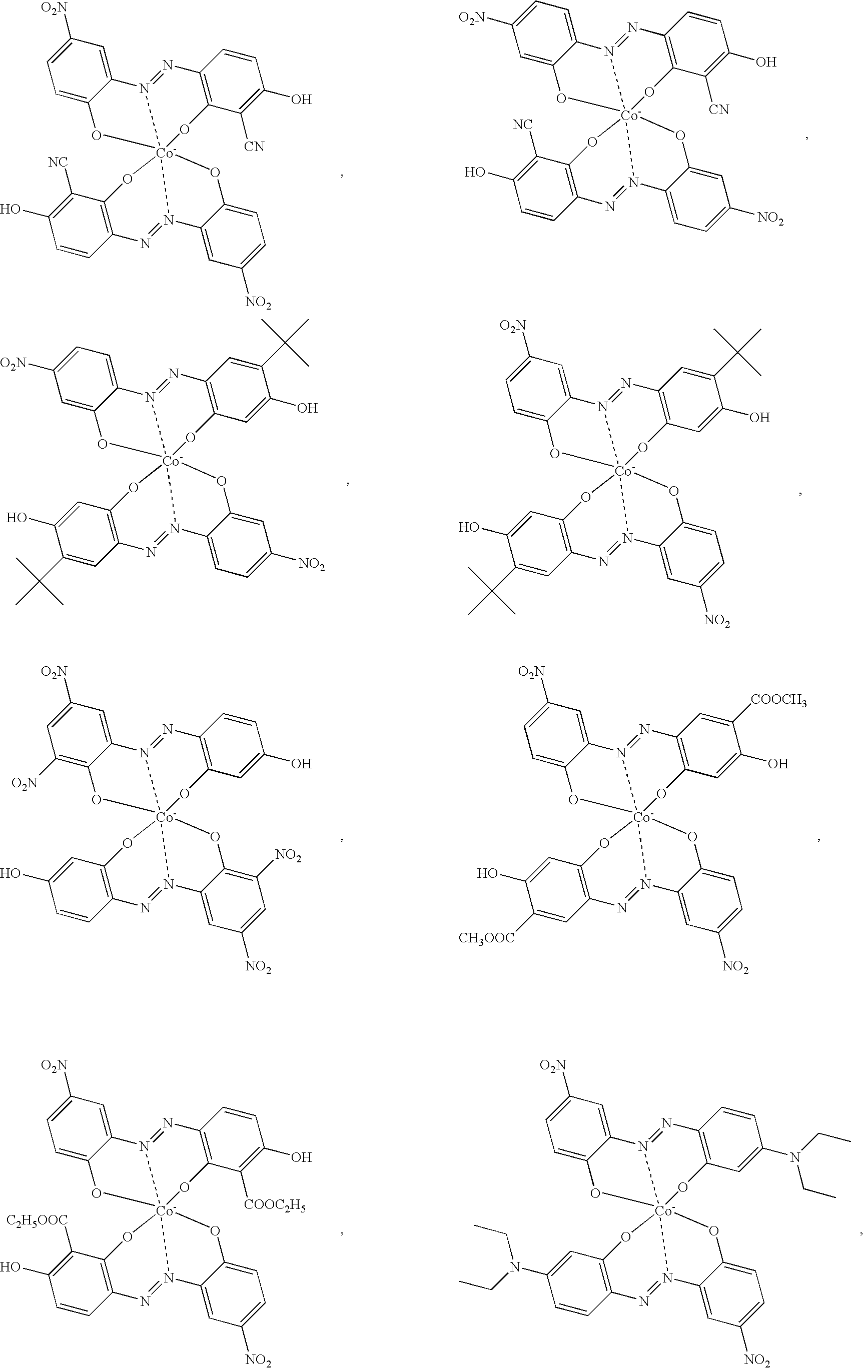

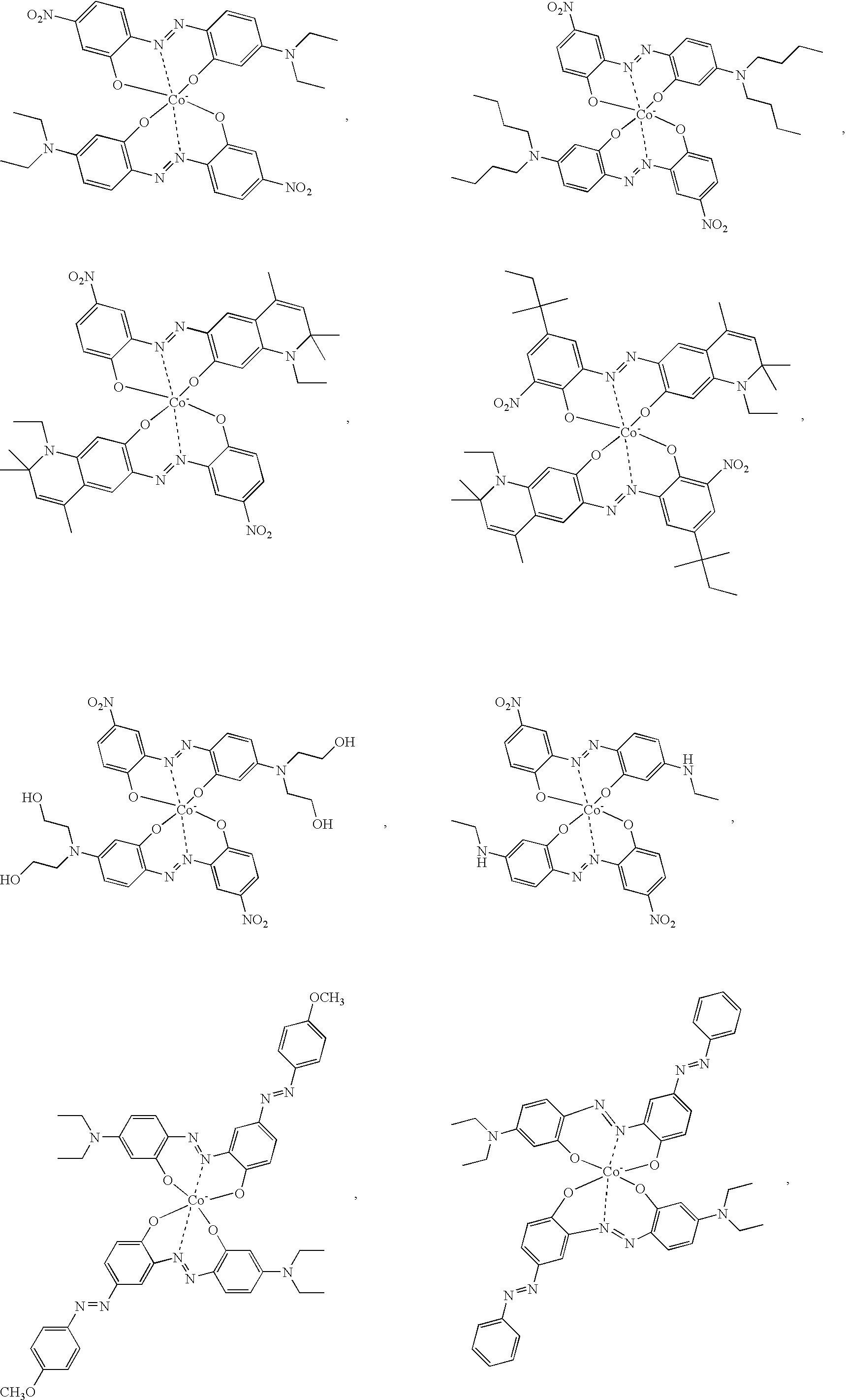

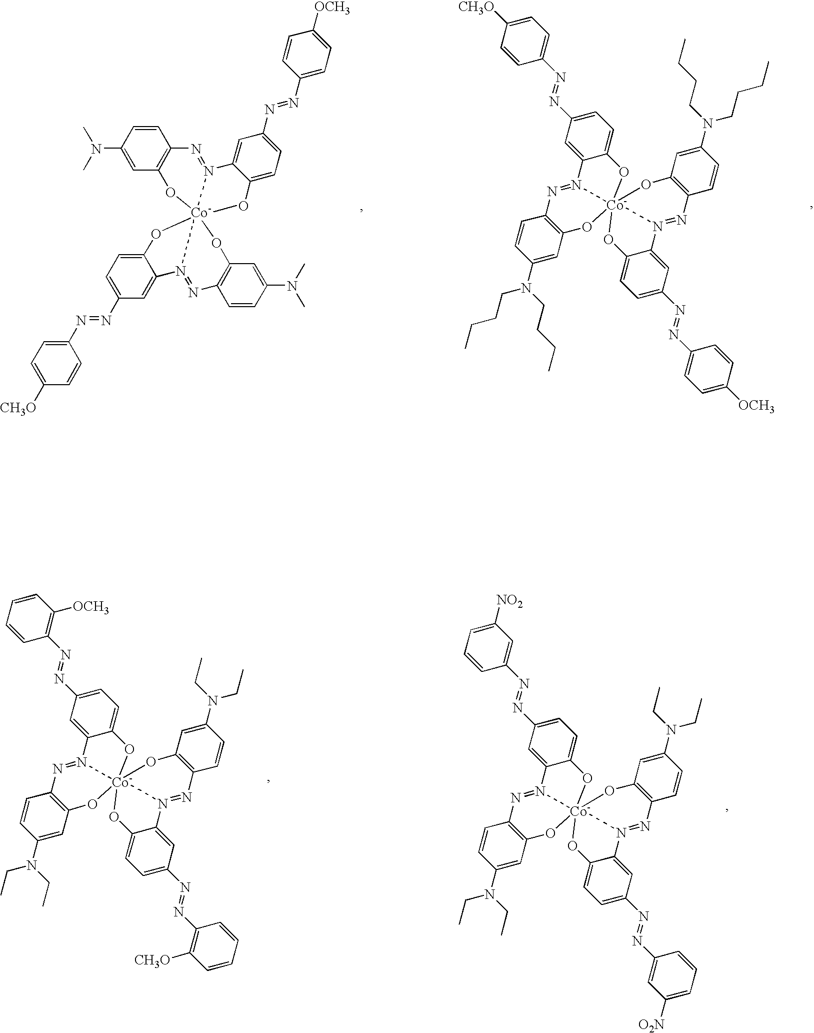

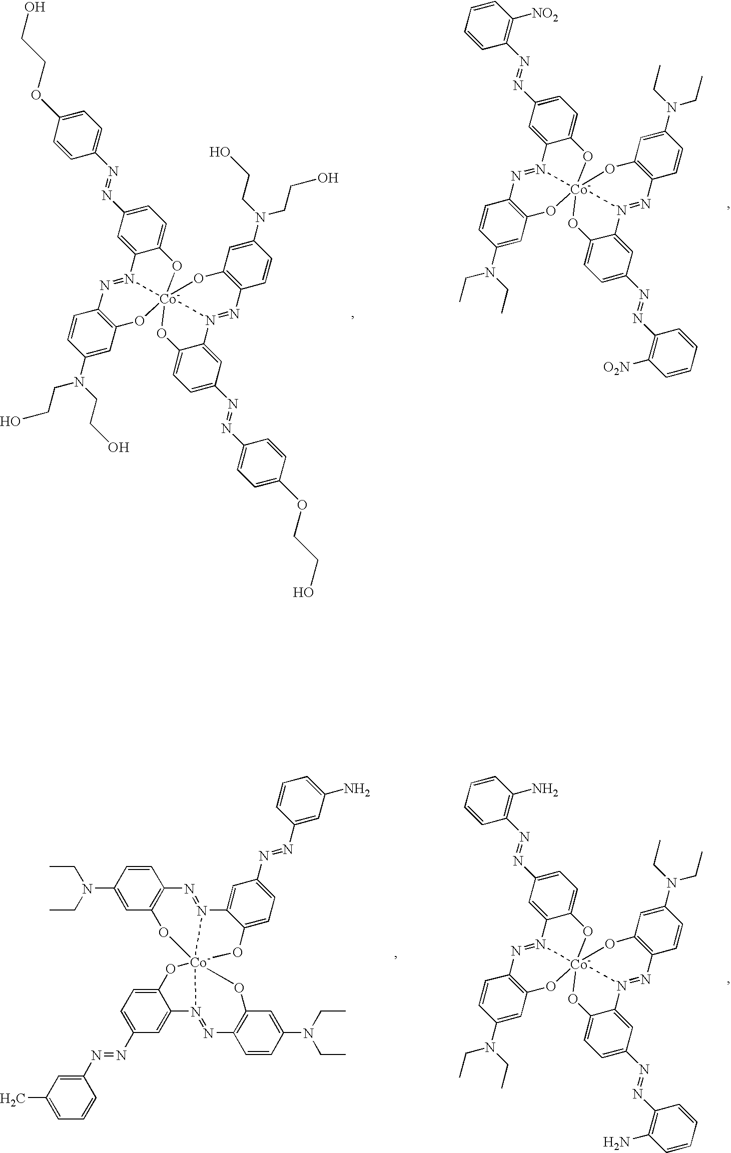

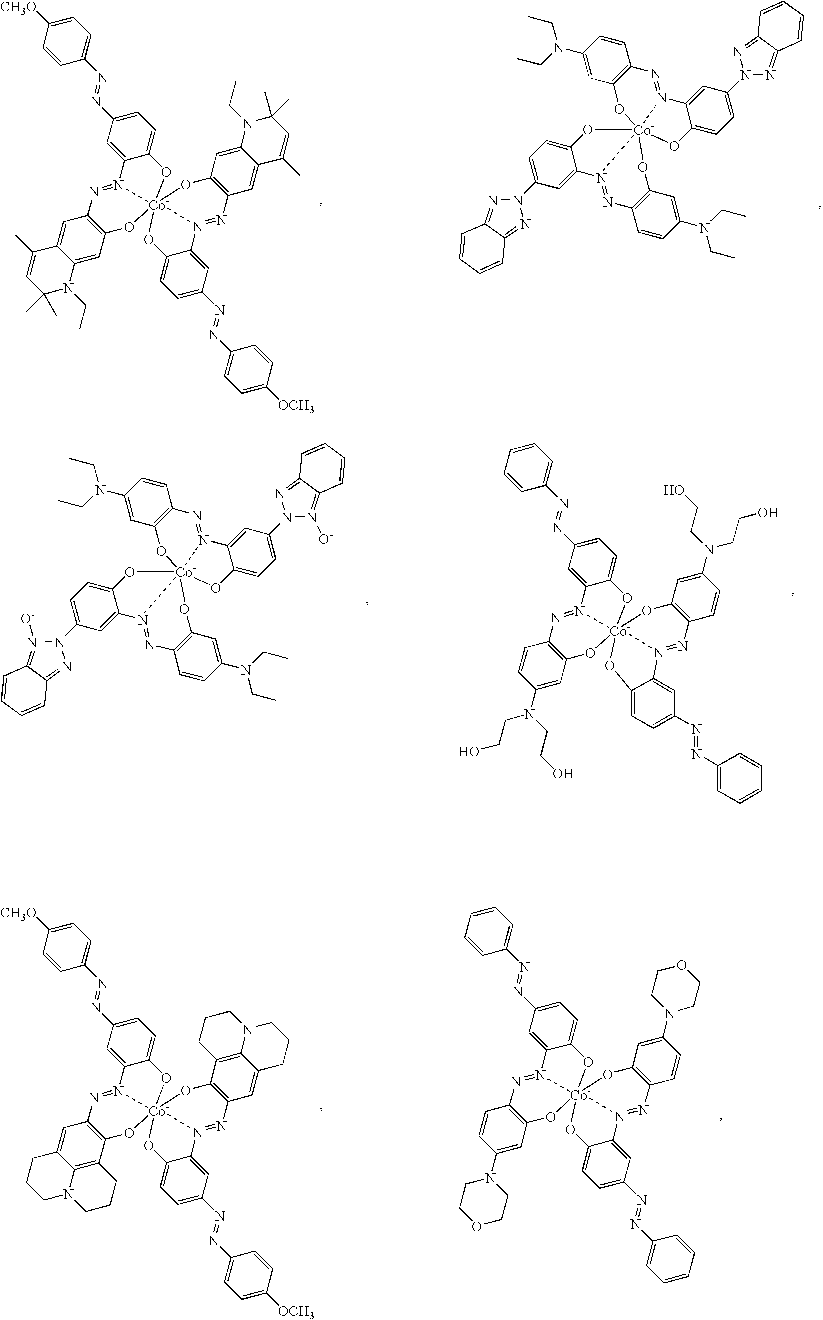

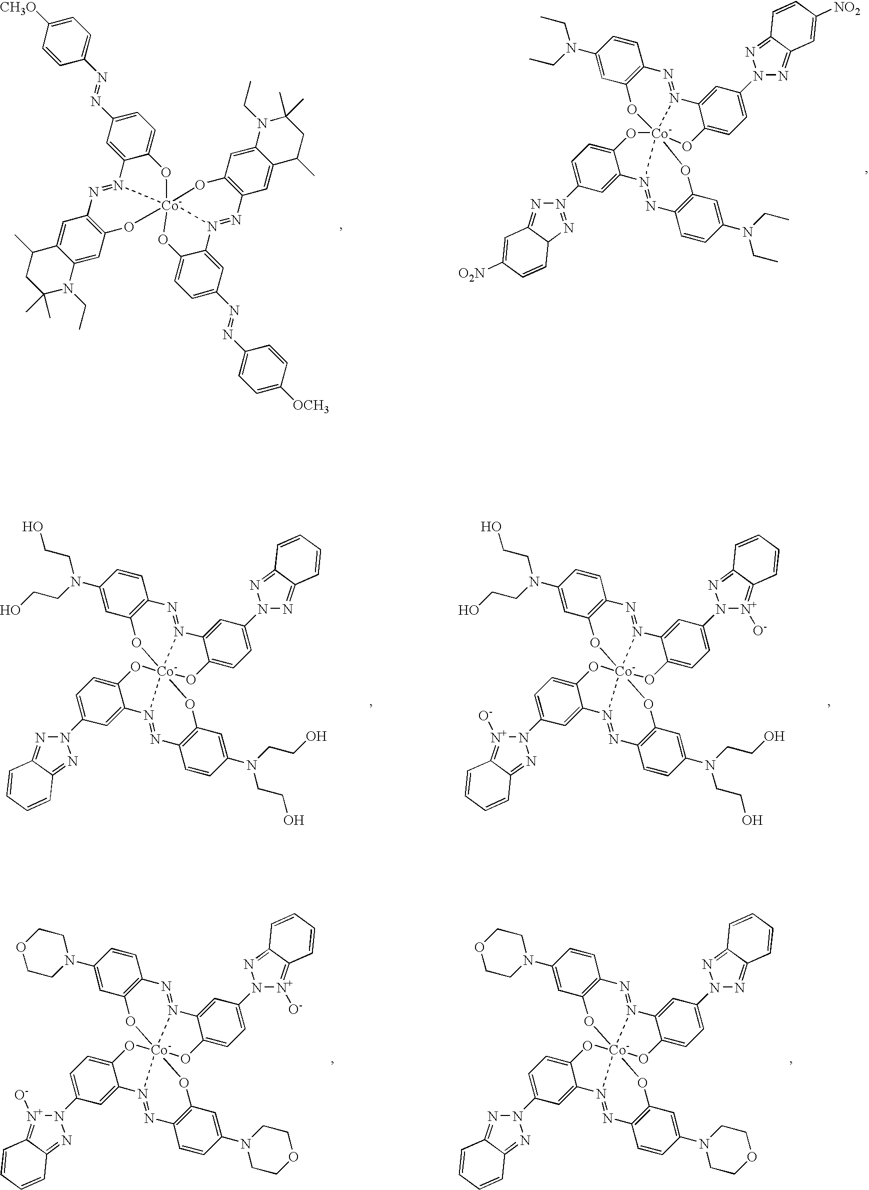

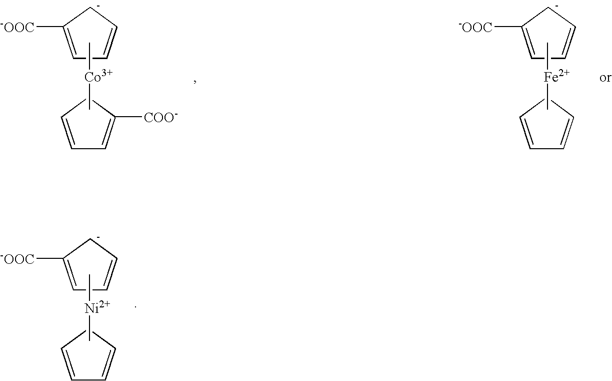

As radicals of organometallic anions that are bonded to the xanthene sub-structure, the following, especially, may be mentioned:

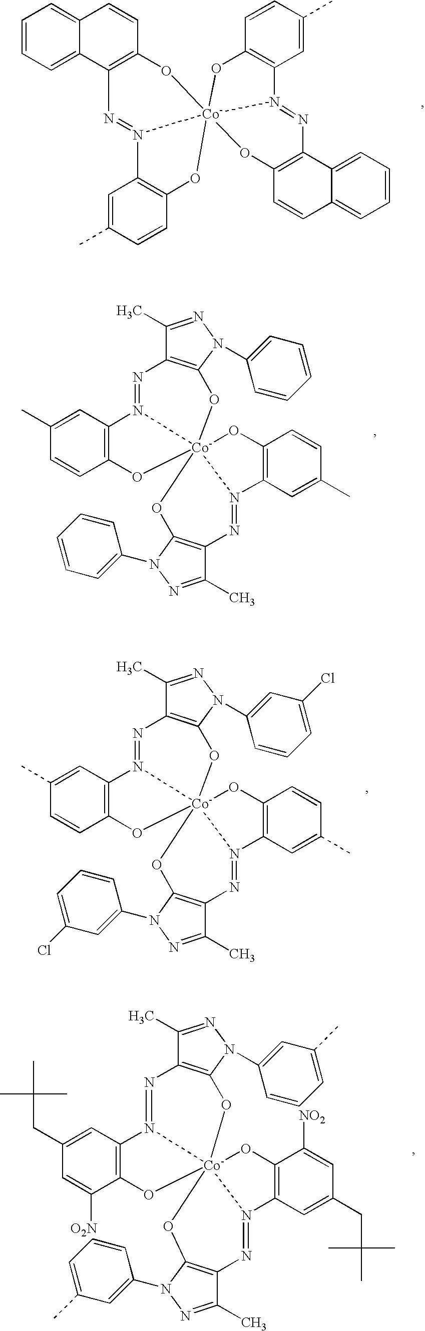

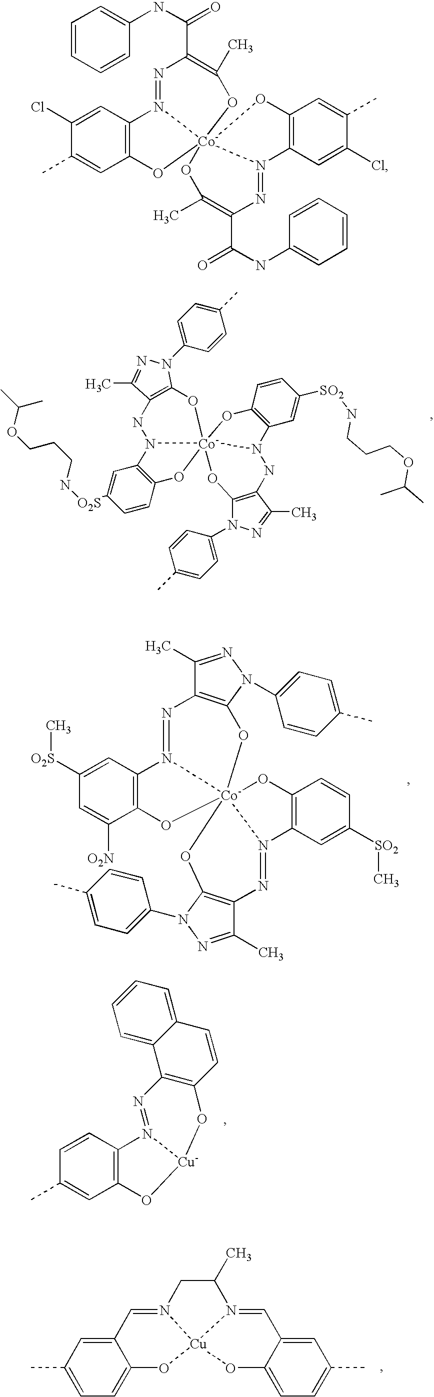

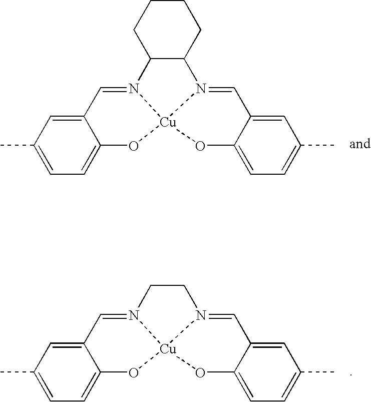

The compounds of formula (I), (II) or (III) are known compounds. Those which are novel can be prepared analogously to the known compounds by methods known per se, useful references being found, for example, in EP 0 853 078, EP 0 853 079 and EP 0 962 497. Metal complexes, preferably those of formula (IV), are well known from the specialist literature. In particular, they may be those metal complexes described in GB 1 599 812 or EP 450 421, and reference is made expressly to the teaching contained therein.

The xanthene dyes used according to the invention have in ethanolic solution a narrow absorption band having its maximum at from 560 to 620 nm, and their half-life band width at a concentration of 10⁻⁵ mol/l is preferably a maximum of 60 nm. Very surprisingly, they also have a comparatively low tendency towards agglomeration in the solid state, so that the absorption curve remains advantageously narrow also in the solid state, especially also in combination with inorganic or organic anions Y^{m-}.

The xanthene dyes used according to the invention also have at the longer wavelength flank of the absorption band a high refractive index which preferably achieves a peak value of from 2.0 to 3.0 in the range from 600 to 700 nm, thereby rendering possible a medium having high reflectivity as well as high sensitivity and good playback characteristics in the desired spectral range. It is furthermore unnecessary to admix a further dye with the recording layer for very good light fastness to be achieved.

The substrate, which functions as support for the layers applied thereto, is advantageously semi-transparent (T≧10%) or preferably transparent (T≧90%). The support can have a thickness of from 0.01 to 10 mm, preferably from 0.1 to 5 mm.

The recording layer is preferably arranged between the transparent substrate and the reflecting layer. The thickness of the recording layer is from 10 to 1000 nm, preferably from 30 to 300 nm, especially about 80 nm, for example from 60 to 120 nm. The absorption of the recording layer is typically from 0.1 to 1.0 at the absorption maximum. The layer thickness is very especially so chosen, in known manner depending upon the respective refractive indices in the non-written state and in the written state at the reading wavelength, that in the non-written state constructive interference is obtained, but in the written state destructive interference is obtained, or vice versa.

The reflecting layer, the thickness of which can be from 1 0 to 150 nm, preferably has high reflectivity (R≧45%, especially R≧60%), coupled with low transparency (T≦10%). In further embodiments, for example in the case of media having a plurality of recording layers, the reflector layer may likewise be semi-transparent, that is to say may have comparatively high transparency (for example T≧50%) and low reflectivity (for example R≦30%).

The uppermost layer, for example the reflective layer or the recording layer, depending upon the layer structure, is advantageously additionally provided with a protective layer which can have a thickness of from 0.1 to 1000 μm, preferably from 0.1 to 50 μm, especially from 0.5 to 15 μm. Such a protective layer can, if desired, serve also as adhesion promoter for a second substrate layer applied thereto, which is preferably from 0.1 to 5 mm thick and consists of the same material as the support substrate.

The reflectivity of the entire recording medium is preferably at least 15%, especially at least 40%.

The main features of the recording layer according to the invention are the very high initial reflectivity in the said wavelength range of the laser diodes, which can be modified with especially high sensitivity; the high refractive index; the narrow absorption band in the solid state; the good uniformity of the script width at different pulse durations; the good light stability; and the good solubility in polar solvents.

The recording medium according to the invention is neither writable nor readable using the infra-red laser diodes of customary CD apparatus in accordance with the requirements of the Orange Book Standard, because at 780 nm the refractive indices (n) characteristically lie between 1.4 and 1.9 and their imaginary components (k) between 0 and a maximum of 0.04. As a result, the risk of damage in the event of an erroneous attempt at writing using an apparatus not capable of high resolution is largely averted, which is of advantage. The use of dyes of formula (I), (II) or (III) results in advantageously homogeneous, amorphous and low-scatter recording layers having a high refractive index, and the absorption edge is surprisingly especially steep even in the solid phase. Further advantages are high light stability in daylight and under laser radiation of low power density with, at the same time, high sensitivity under laser radiation of high power density, uniform script width, high contrast, and also good thermal stability and storage stability.

At a relatively high recording speed, the results obtained are surprisingly better than with previously known recording media. The marks are more precisely defined relative to the surrounding medium, and thermally induced deformations do not occur. The error rate (BLER) and the statistical variations in mark length (jitter) are also low both at normal recording speed and at relatively high recording speed, so that an error-free recording and playback can be achieved over a large speed range. There are virtually no rejects even at high recording speed, and the reading of written media is not slowed down by the correction of errors. The advantages are obtained over the entire range of from 600 to 700 nm (preferably from 630 to 690 nm), but are especially marked at from 640 to 680 nm, more especially from 650 to 670 nm, very especially at 658±5 nm.

Suitable substrates are, for example, glass, minerals, ceramics and thermosetting or thermoplastic plastics. Preferred supports are glass and homo- or co-polymeric plastics. Suitable plastics are, for example, thermoplastic polycarbonates, polyamides, polyesters, polyacrylates and polymethacrylates, polyurethanes, polyolefins, polyvinyl chloride, polyvinylidene fluoride, polyimides, thermosetting polyesters and epoxy resins. The substrate can be in pure form or may also comprise customary additives, for example UV absorbers or dyes, as proposed e.g. in JP 04/1 67 239 as light stabilisers for the recording layer. In the latter case it may be advantageous for the dye added to the support substrate to have an absorption maximum hypsochromically shifted relative to the dye of the recording layer by at feast 1 0 nm, preferably by at least 20 nm.

The substrate is advantageously transparent over at least a portion of the range from 600 to 700 nm (preferably as indicated above), so that it is permeable to at least 90% of the incident light of the writing or readout wavelength. The substrate has preferably on the coating side a spiral guide groove having a groove depth of from 50 to 500 nm, a groove width of from 0.2 to 0.8 μm and a track spacing between two turns of from 0.4 to 1.6 μm, especially having a groove depth of from 100 to 200 nm, a groove width of 0.3 μm and a spacing between two turns of from 0.6 to 0.8 μm. The storage media according to the invention are therefore suitable especially advantageously for the optical recording of DVD media having the currently customary pit width of 0.4 μm and track spacing of 0.74 μm. The increased recording speed relative to known media allows synchronous recording or, for special effects, even accelerated recording of video sequences with excellent image quality.

The recording layer, instead of comprising a single compound of formula (I), (II) or (III), may also comprise a mixture of such compounds having, for example, 2, 3, 4 or 5 xanthene dyes according to the invention. By the use of mixtures, for example mixtures of isomers or homologues as well as mixtures of different structures, the solubility can often be increased and/or the amorphous content improved. If desired, mixtures of ion pair compounds may have different anions, different cations or both different anions and different cations.

For a further increase in stability it is also possible, if desired, to add known stabilisers in customary amounts, for example a nickel dithiolate described in JP 04/025 493 as light stabiliser.

The recording layer comprises a compound of formula (I), (II) or (III) or a mixture of such compounds advantageously in an amount sufficient to have a substantial influence on the refractive index, for example at least 30% by weight, preferably at least 60% by weight, especially at least 80% by weight. The recording layer can especially valuably comprise a compound of formula (I), (II) or (III) or a mixture of a plurality of such compounds as main component, or may consist exclusively or substantially of one or more compounds of formula (I), (II) or (III).

Further customary constituents are possible, for example other chromophores (for example those having an absorption maximum at from 300 to 1000 nm), UV absorbers and/or other stabilisers, ¹O₂—, triplet- or luminescence-quenchers, melting-point reducers, decomposition accelerators or any other additives that have already been described in optical recording media, for example film formers.

When the recording layer comprises further chromophores, they may in principle be any dye that can be decomposed or modified by the laser radiation during recording, or they may be inert towards the laser radiation. When the further chromophores are decomposed or modified by the laser radiation, this can take place directly by absorption of the laser radiation or can be induced indirectly by the decomposition of the compounds of formula (I), (II) or (III) according to the invention, for example thermally.

Naturally, further chromophores or coloured stabilisers may influence the optical properties of the recording layer. It is therefore preferable to use further chromophores or coloured stabilisers, the optical properties of which conform as far as possible to those of the compounds formula (I), (II) or (III) or are as different as possible, or the amount of further chromophores is kept small.

When further chromophores having optical properties that conform as far as possible to those of the compounds of formula (I), (II) or (III) are used, preferably this should be the case in the range of the longest-wavelength absorption flank. Preferably the wavelengths of the inversion points of the further chromophores and of the compounds of formula (I), (II) or (III) are a maximum of 20 nm, especially a maximum of 10 nm, apart. In that case the further chromophores and the compounds of formula (I), (II) or (III) should exhibit similar behaviour in respect of the laser radiation, so that it is possible to use as further chromophores known recording agents the action of which is synergistically enhanced or heightened by the compounds of formula (I), (II) or (III).

When further chromophores or coloured stabilisers having optical properties that are as different as possible from those of the compounds of formula (I), (II) or (III) are used, they advantageously have an absorption maximum that is hypsochromically or bathochromically shifted relative to the dye of formula (I), (II) or (III). In that case the absorption maxima are preferably at least 50 nm, especially at least 100 nm, apart. Examples thereof are UV absorbers that are hypsochromic to the dye of formula (I), (II) or (III), or coloured stabilisers that are bathochromic to the dye of formula (I), (II) or (III) and have absorption maxima lying, for example, in the NIR or IR range. Other dyes can also be added for the purpose of colour-coded identification, colour-masking (“diamond dyes”) or enhancing the visual appearance of the recording layer. In all those cases, the further chromophores or coloured stabilisers should preferably exhibit behaviour towards light radiation and laser radiation that is as inert as possible.

When another dye is added in order to modify the optical properties of the compounds of formula (I), (II) or (III), the amount thereof is dependent upon the optical properties to be achieved. The person skilled in the art will find little difficulty in varying the ratio of additional dye to compound of formula (I), (II) or (III) until he obtains the result he desires.

When chromophores or coloured stabilisers are used for other purposes, the amount thereof should preferably be small so that their contribution to the total absorption of the recording layer in the range of from 600 to 700 nm is a maximum of 20%, preferably a maximum of 10%. In such a case, the amount of additional dye or stabiliser is advantageously a maximum of 50% by weight, preferably a maximum of 10% by weight, based on the recording layer.

Most preferably, however, no additional chromophore is added, unless it is a coloured stabiliser.

Further chromophores that can be used in the recording layer in addition to the compounds of formula (I), (II) or (III) are, for example, cyanines and cyanine metal complexes (U.S. Pat. No. 5,958,650), styryl compounds (U.S. Pat. No. 6,103,331), oxonol dyes (EP-A-833 314), azo dyes and azo metal complexes OP-A-11/028865), phthalocyanines (EP-A-232 427, EP-A-337 209, EP-A-373 643, EP-A-463 550, EP-A-492 508, EP-A-509 423, EP-A-511 590, EP-A-513 370, EP-A-514 799, EP-A-518 213, EP-A-519 419, EP-A-519 423, EP-A-575 816, EP-A-600 427, EP-A-676 751, EP-A-712 904, WO-98/14520, WO-00/09522, CH-693/01), porphyrins and azaporphyrins (EP-A-822 546, U.S. Pat. No. 5,998,093), dipyrromethene dyes and metal chelate compounds thereof (EP-A-822 544, EP-A-903 733), xanthene dyes and metal complex salts thereof (U.S. Pat. No. 5,851,621) or quadratic acid compounds (EP-A-568 877), or oxazines, dioxazines, diazastyryls, formazans, anthraquinones or phenothiazines; this list is on no account exhaustive and the person skilled in the art will interpret the list as including further known dyes.

Stabilisers or fluorescence quenchers are, for example, metal complexes of N— or S-containing enolates, phenolates, bisphenolates, thiolates or bisthiolates or of azo, azomethine or formazan dyes, such as ®Irgalan Bordeaux EL (Ciba Spezialitatenchemie AG), ®Cibafast N3 (Ciba Spezialitätenchemie AG) or similar compounds, hindered phenols and derivatives thereof (optionally also as anions Xe), such as ®Cibafast AO (Ciba Spezialitatenchemie AG), hydroxyphenyl-triazoles or -triazines or other UV absorbers, such as ®Cibafast W or ®Cibafast P (Ciba Spezialitatenchemie AG) or hindered amines (TEMPO or HALS, also as nitroxides or NOR-HALS, optionally also as anions X⁻).

Many such structures are known, some of them also in connection with optical recording media, for example from U.S. Pat. No. 5,219,707, JP-A-06/199045, JP-A-07/76169 or JP-A-07/262604. They may be, for example, salts of the metal complex anions disclosed above with any desired cations, for example the cations disclosed above.

Also suitable are neutral metal complexes, for example those metal complexes disclosed in EP 0 822 544, EP 0 844 243, EP 0 903 733, EP 0 996 123, EP 1 056 078, EP 1 130 584, U.S. Pat. No. 6,162,520 or PCT/EP02/12425, for example 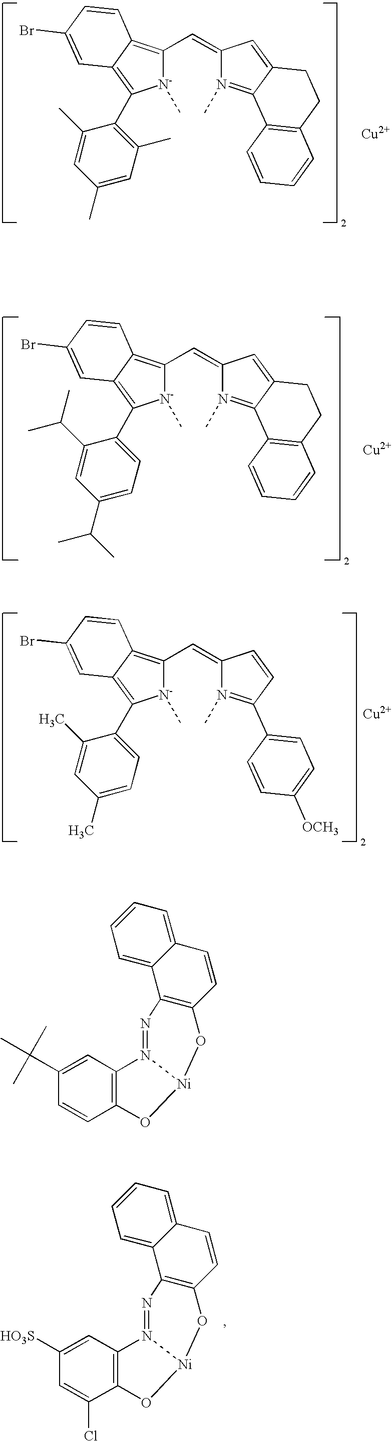 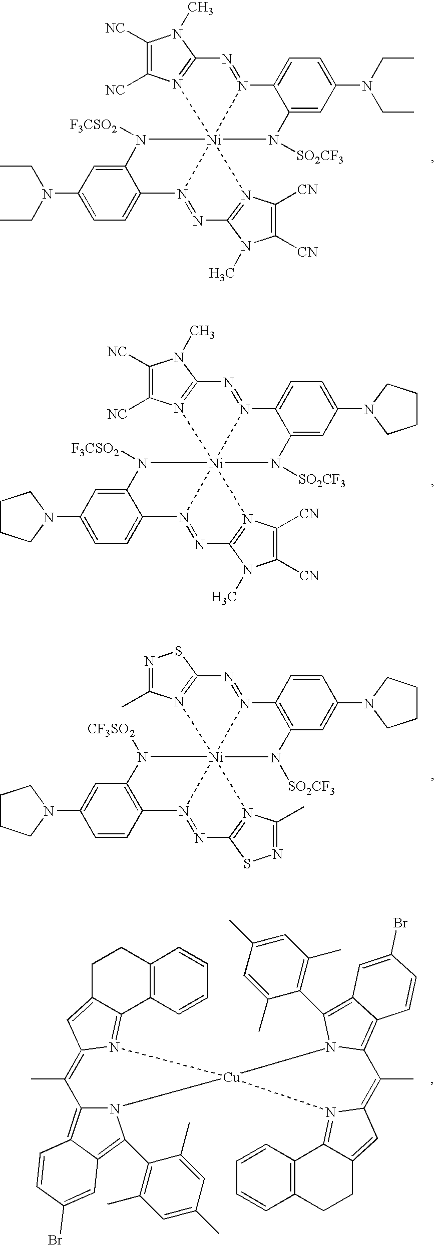 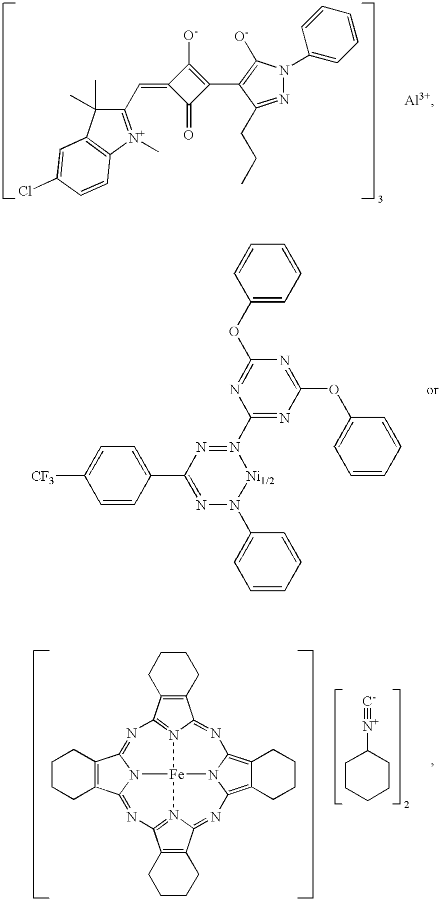
and also those of formula (L₃)M₂(L₅) (V), (L₆)M₂(L₇) (VI) or M₂(L₈) (VII), wherein L₅ is C₁-C₁₂alkyl-OH, C₆-C₁₂aryl-OH, C₇-C₁₂aralkyl-OH, C₁-C₁₂alkyl-SH, C₆-C₁₂aryl-SH, C₇-C₁₂aralkyl-SH, C₁-C₁₂alkyl-NH₂, C₆-C₁₂aryl-NH₂, C₇-C₁₂aralkyl-NH₂, di-C₁-C₁₂alkyl-NH, di-C₆-C₁₂aryl-NH, di-C₇-C₁₂aralkyl-NH, tri-C₁-C₁₂alkyl-N, tri-C₆-C₁₂aryl-N or tri-C₇-C₁₂aralkyl-N, L₆ and L₇ are 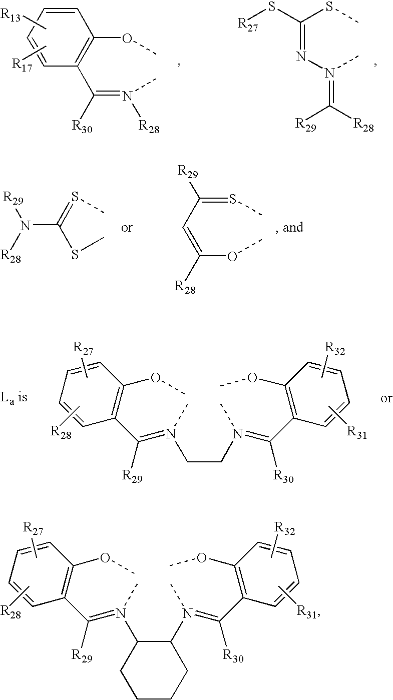
M₂ and R₂₈ to R₃₂ being as defined above.

A particular example of an additive of formula (VII) that may be mentioned is a copper complex, illustrated, for example, by the compound of formula

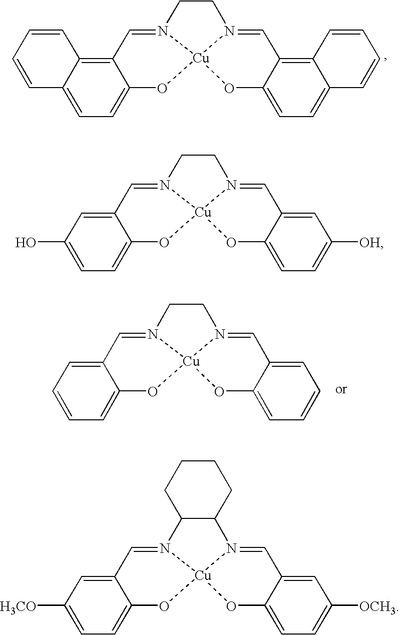

A particular example of an additive of formula (V) that may be mentioned is a nickel bisphenolate, illustrated, for example, by the compound of formula

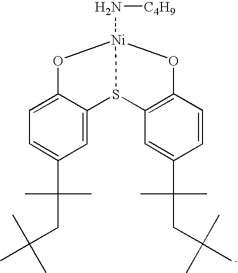

The person skilled in the art will know from other optical information media, or will easily identify, which additives in which concentration are especially well suited to which purpose. Suitable concentrations of additives are, for example, from 0.001 to 1000% by weight, preferably from 1 to 50% by weight, based on the recording agent of formula (I), (II) or (III).

The recording medium according to the invention, besides comprising a compound of formula (I), (II) or (III), may additionally comprise salts, for example ammonium chloride, pentadecylammonium chloride, sodium chloride, sodium sulfate, sodium methyl sulfonate or sodium methyl sulfate, the ions of which may originate e.g. from the components used. The additional salts, if present, are present preferably in amounts of up to 20% by weight, based on the total weight of the recording layer.

Reflecting materials suitable for the reflective layer include especially metals, which provide good reflection of the laser radiation used for recording and playback, for example the metals of Main Groups 111, IV and V and of the Sub-Groups of the Periodic Table of the Elements. Al, In, Sn, Pb, Sb, Bi, Cu, Ag, Au, Zn, Cd, Hg, Sc, Y, La, Ti, Zr, Hf, V, Nb, Ta, Cr, Mo, W, Fe, Co, Ni, Ru, Rh, Pd, Os, Ir, Pt, Ce, Pr, Nd, Pm, Sm, Eu, Gd, Tb, Dy, Ho, Er, Tm, Yb and Lu and alloys thereof are especially suitable. Special preference is given to a reflective layer of aluminium, silver, copper, gold or an alloy thereof, on account of the high reflectivity and ease of production thereof.

Materials suitable for the protective layer include chiefly plastics, which are applied in a thin layer to the support or the uppermost layer either directly or with the aid of adhesive layers. It is advantageous to select mechanically and thermally stable plastics having good surface properties, which may be modified further, for example written.

The plastics may be thermosetting plastics and thermoplastic plastics. Preference is given to radiation-cured (e.g using UV radiation) protective layers, which are particularly simple and economical to produce. A wide variety of radiation-curable materials are known. Examples of radiation-curable monomers and oligomers are acrylates and methacrylates of diols, triols and tetrols, polyimides of aromatic tetra-carboxylic acids and aromatic diamines having C₁-C₄alkyl groups in at least two ortho-positions of the amino groups, and oligomers having dialkylmaleimidyl groups, e.g. dimethylmaleimidyl groups.

The recording media according to the invention may also have additional layers, for example interference layers. It is also possible to construct recording media having a plurality of (for example two) recording layers. The structure and the use of such materials are known to the person skilled in the art. Preferably, interference layers, if present, are arranged between the recording layer and the reflecting layer and/or between the recording layer and the substrate and consist of a dielectric material, for example as described in EP 353 393 of TiO₂, Si₃N₄, ZnS or silicone resins.

The recording media according to the invention can be produced by processes known per se, various methods of coating being employable depending upon the materials used and their function.

Suitable coating methods are, for example, dipping, pouring, brush-coating, knife-application and spin-coating, as well as vapour-deposition methods carried out under a high vacuum. When pouring methods, for example, are employed, solutions in organic solvents are generally used. When solvents are employed, care should be taken that the supports used are insensitive to those solvents. Suitable coating methods and solvents are described, for example, in EP-A401 791.

The recording layer is applied preferably by spin-coating with a dye solution, solvents that have proved satisfactory being especially alcohols, e.g. 2-methoxyethanol, 1-methoxy-2-propanol, cyclopentanol, n-propanol, isopropanol, isobutanol, n-butanol, amyl alcohol or 3-methyl-1-butanol or preferably fluorinated alcohols, e.g. 2,2,2-tri-fluoroethanol or 2,2,3,3-tetrafluoro-1-propanol, and mixtures thereof. It will be understood that other solvents or solvent mixtures can also be used, for example those solvent mixtures described in EP-A-511 598 and EP-A-833 316. Ethers (dibutyl ether), ketones (2,6-dimethyl-4-heptanone, 5-methyl-2-hexanone) or saturated or unsaturated hydrocarbons (toluene, xylene) can also be used, for example in the form of mixtures (e.g. dibutyl ether/2,6-dimethyl-4-heptanone) or mixed components.

The excellent solubility of the instant compounds enables high concentrations in the spin-coating solvent, usually from 0.5 to 20% by weight, preferably from 1 to 10% by weight, especially from about 2 to 7% by weight, based on the solution.

It has, however, very surprisingly been found that, for applying dye solutions to grooved support materials by spin-coating, there can very especially advantageously be used lactates, preferably compounds of formula 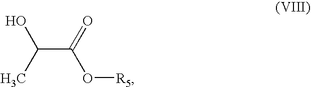
wherein R₅ has the same definitions and preferred meanings as hereinbefore.

The compounds of formula (VIII) can be used either in the form of pure R or S optical isomers or in the form of mixtures thereof (for example racemates), but they are preferably used in the form of the S isomer. Most preferred is methyl-(S)-lactate. Where there are optically active centres in R₁, such as, for example, in 2-ethyl-hexyl, the number of possible isomers is increased, it being possible for both optically active alcohols and racemates to be used for the esterification.

The invention accordingly relates to a method of applying a dye solution to a grooved support material by spin-coating, wherein the dye solution comprises a compound of formula (I), (II) or (III) and, as solvent, a compound of formula

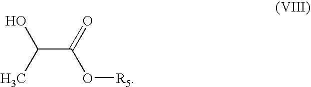

The solvent contains The solvent contains preferably from 0.3 to 100% by weight, especially from 5 to 80% by weight, more especially from 10 to 50% by weight, of the compound of formula (VIII), based on total solvent, it being possible for the remainder, where applicable, to consist of one or more different solvents.

The person skilled in the art of spin-coating will in general routinely try out all the solvents with which he is familiar, as well as binary and ternary mixtures thereof, in order to discover the solvents or solvent mixtures which result in a high-quality and, at the same time, cost-effective recording layer containing the solid components of his choice. Known methods of process engineering can also be employed in such optimisation procedures, so that the number of experiments to be carried out can be kept to a minimum.

The invention therefore relates also to a method of producing an optical recording medium, wherein a solution of a compound of formula (I), (II) or (III) in an organic solvent is applied to a substrate having pits. The application is preferably carried out by spin-coating.

The application of the metallic reflective layer is preferably effected by sputtering, vapour-deposition in vacuo or by chemical vapour deposition (CVD). The sputtering technique is especially preferred for the application of the metallic reflective layer on account of the high degree of adhesion to the support. Such techniques are known and are described in specialist literature (e.g. J. L. Vossen and W. Kern, “Thin Film Processes”, Academic Press, 1978).

The structure of the recording medium according to the invention is governed primarily by the readout method; known function principles include the measurement of the change in transmission or, preferably, in reflection, but it is also known, for example, to measure the fluorescence instead of the transmission or reflection.

When the recording material is structured for a change in reflection, the following structures, for example, can be used: transparent support/recording layer (optionally multilayered)/reflective layer and, if expedient, protective layer (not necessarily transparent); or support (not necessarily transparent)/reflective layer/recording layer and, if expedient, transparent protective layer. In the first case, the light is incident from the support side, whereas in the latter case the radiation is incident from the recording layer side or, where applicable, from the protective layer side. In both cases the light detector is located on the same side as the light source. The first-mentioned structure of the recording material to be used according to the invention is generally preferred.

When the recording material is structured for a change in light transmission, the following different structure, for example, comes into consideration: transparent support/recording layer (optionally multilayered) and, if expedient, transparent protective layer. The light for recording and for readout can be incident either from the support side or from the recording layer side or, where applicable, from the protective layer side, the light detector in that case always being located on the opposite side.

Suitable lasers are those having a wavelength of from 600 to 700 nm, for example commercially available lasers having a wavelength of 602, 612, 633, 635, 647, 650, 670 or 680 nm, especially semi-conductor lasers, such as GaAsAl, InGaAlP or GaAs laser diodes having a wavelength especially of about 635, 650 or 658 nm. The recording is effected, for example, point for point in a manner known per se, by modulating the laser in accordance with the mark lengths and focussing its radiation onto the recording layer. It is known from the specialist literature that other methods are currently being developed which may also be suitable for use.

The method according to the invention allows the storage of information with great reliability and stability, distinguished by very good mechanical and thermal stability and by high light stability and by sharp boundary zones of the pits. Special advantages include the high contrast, the low jitter and the surprisingly high signal/noise ratio, with the result that excellent readout is achieved. The high storage capacity is especially valuable in the field of video.

The readout of information is carried out according to methods known per se by registering the change in absorption or reflection using laser radiation, for example as described in “CD-Player und R-DAT Recorder” (Claus Biaesch-Wiepke, Vogel Buchverlag, Wurzburg 1992).

The information-containing medium according to the invention is especially an optical information material of the WORM type. It may be used, for example, as a playable DVD (digital versatile disk), as storage material for a computer or as an identification and security card or for the production of diffractive optical elements, for example holograms.

The invention accordingly relates also to a method for the optical recording, storage or playback of information, wherein a recording medium according to the invention is used. The recording and/or playback advantageously take place in a wavelength range of from 600 to 700 nm, preferably in the manner already indicated.

The following Examples illustrate the invention in greater detail:

### EXAMPLE 1

### 1.5% By Weight of the Product of Formula

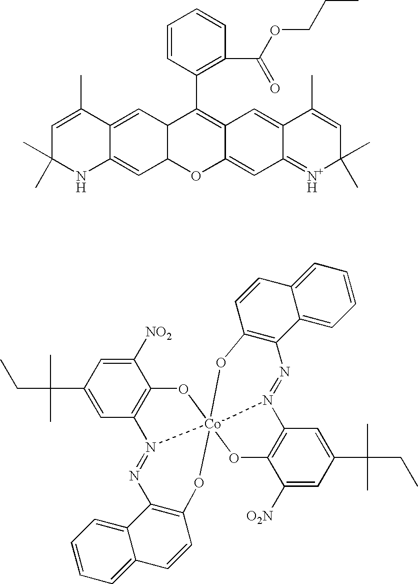 is dissolved in 2,2,3,3-tetrafluoro-1-propanol and the solution is filtered through a Teflon filter having a pore size of 0.2 μm and applied at 1500 rev/min. by the spin-coating method to the surface of a 0.6 mm thick, grooved polycarbonate disc (groove depth: 190 nm, groove width 290 nm, track spacing 0.74 μm) having a diameter of 120 mm. The excess of solution is spun off by increasing the rotational speed. On evaporation of the solvent, the dye remains behind in the form of a uniform, amorphous solid layer. After drying in a circulating-air oven at 70° C. (10 min), the solid layer exhibits an absorption of 0.52 at 61 nm. A 60 nm thick layer of silver is then applied by atomisation to the resulting recording layer in a vacuum coating apparatus (Twister, Balzers Unaxis). Then a 6 μm thick protective layer of a UV-curable photo-polymer (650-020, DSM) is applied thereto by means of spin-coating. The recording support exhibits a reflectivity of 50% at 658 nm. Using a commercial recording apparatus (Pioneer A03 DVD-R(G)), marks are written into the active layer at a speed of 3.5 m/sec and a laser power of 9.8 mW using a laser diode of wavelength 658 nm. The following dynamic parameters are then determined on a commercial test apparatus (DVD Pro, Audio Dev): DTC Jitter=8.1 %, R14H=50%, I14/I14H=0.53. Overall, all measurement values were good.

### EXAMPLE 2

### The Procedure is Analogous to Example 1, But Instead There is Used the Compound of Formula

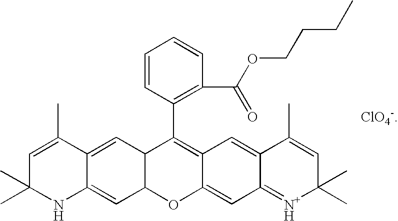

### EXAMPLE 3

### The Procedure is Analogous to Example 1, But Instead There is Used the Compound of Formula

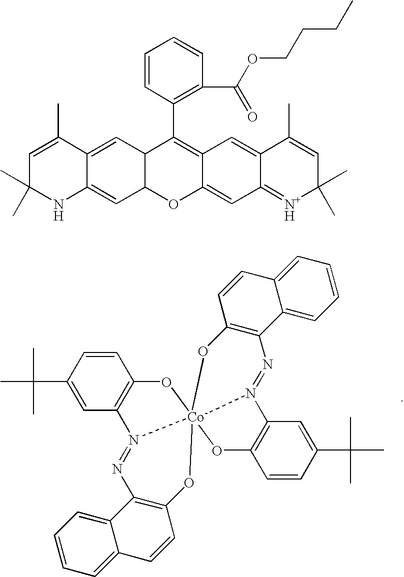

### EXAMPLE 4

### The Procedure is Analogous to Example 1, But Instead There is Used the Compound of Formula

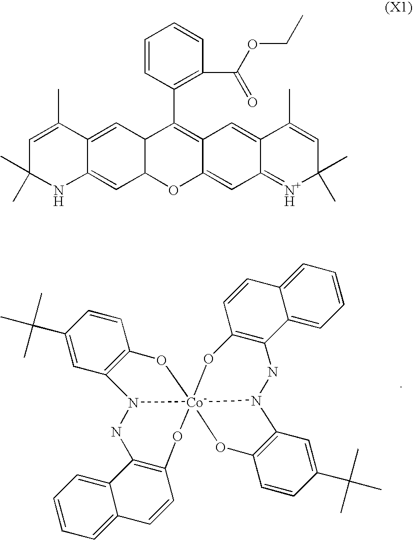

### EXAMPLES 5-47

### The Procedure is Analogous to Example 1, But Instead the Following Compounds are Used (Optical Values of the Solid Layers are Given in Each Case):

| Structure | k₆₅₈ | n₆₅₈ | nₘₐₓ |
|---|---|---|---|
| 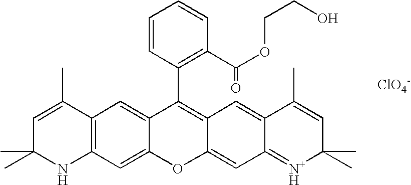 | 0.026 | 2.19 | 2.55 |
| 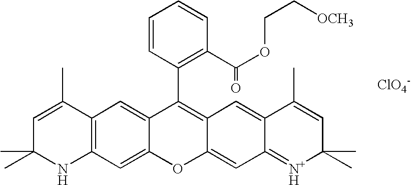 | 0.020 | 2.17 | 2.60 |
| 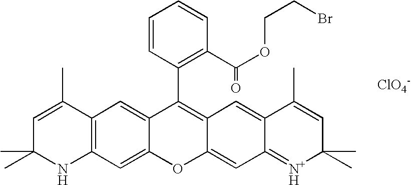 | 0.025 | 2.18 | 2.55 |
| 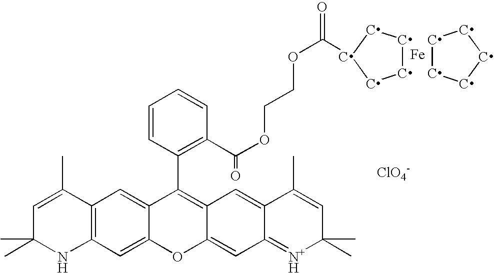 | 0.022 | 2.16 | 2.43 |
| 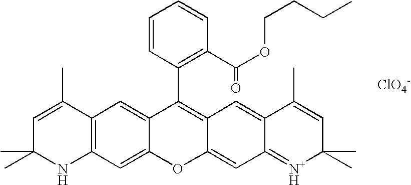 | 0.021 | 2.23 | 2.57 |
| 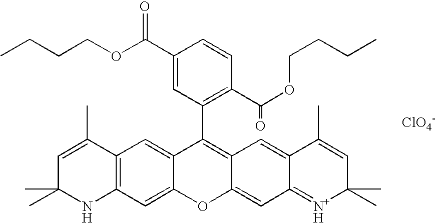 | 0.024 | 2.21 | 2.47 |
| 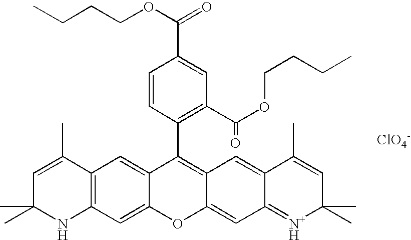 | 0.046 | 2.24 | 2.41 |
| 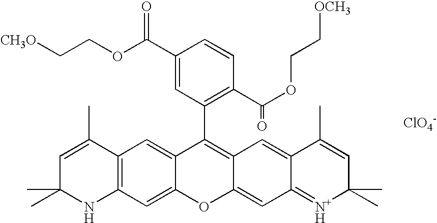 | 0.034 | 2.21 | 2.50 |
| 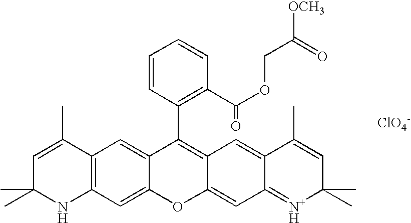 | 0.041 | 2.32 | 2.60 |
| 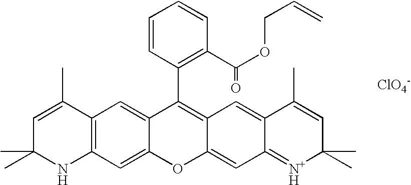 | 0.025 | 2.18 | 2.57 |
| 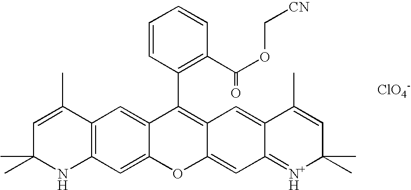 | 0.054 | 2.28 | 2.60 |
| 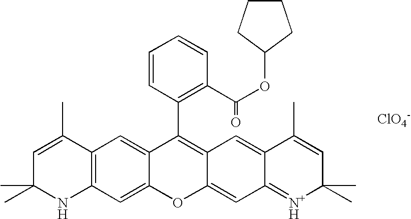 | 0.036 | 2.15 | 2.57 |
| 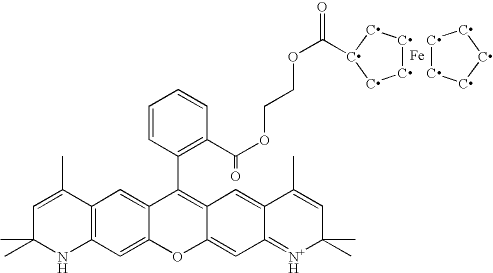 | 0.038 | 1.99 | 2.21 |
| 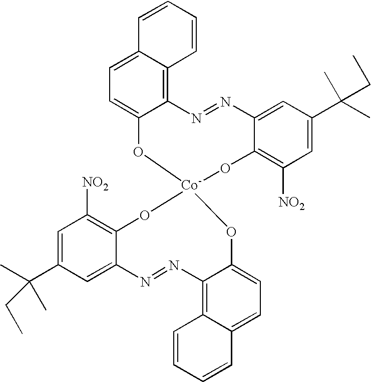 | | | |
| 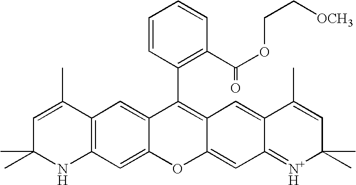 | 0.083 | 2.01 | 2.25 |
| 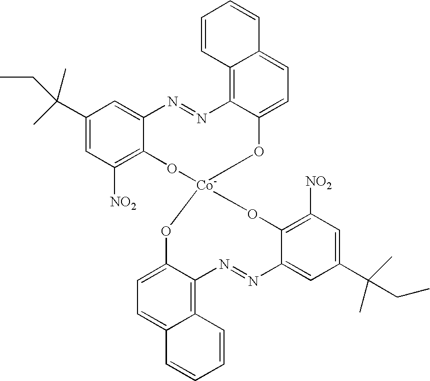 | | | |
| 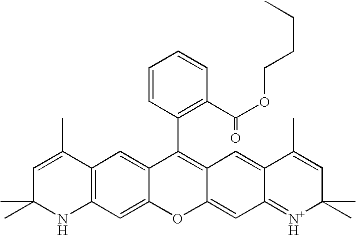 | 0.039 | 2.15 | 2.45 |
| 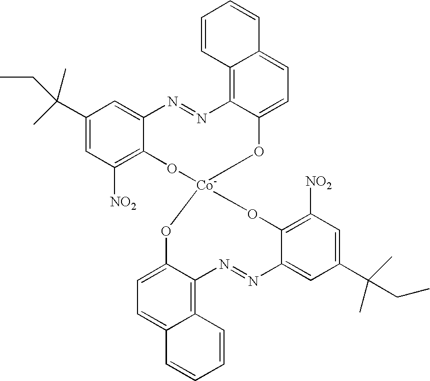 | | | |
| 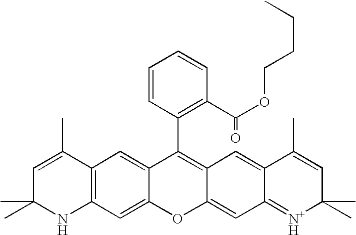 | 0.107 | 1.93 | 2.08 |
| 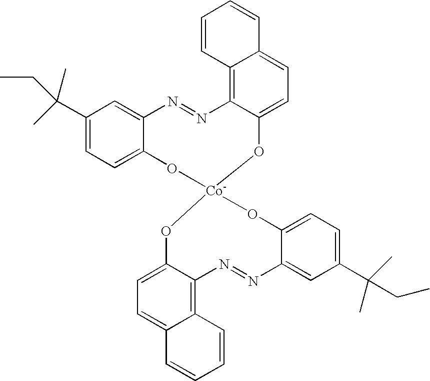 | | | |
| 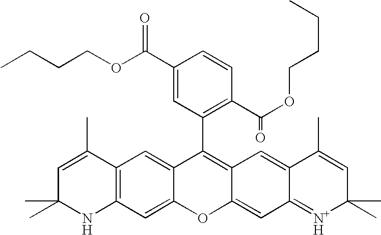 | 0.054 | 2.10 | 2.31 |
| 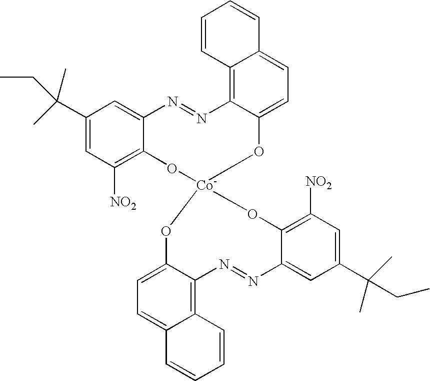 | | | |
| 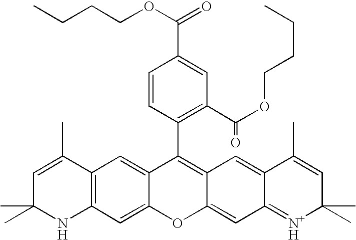 | 0.060 | 2.10 | 2.29 |
| 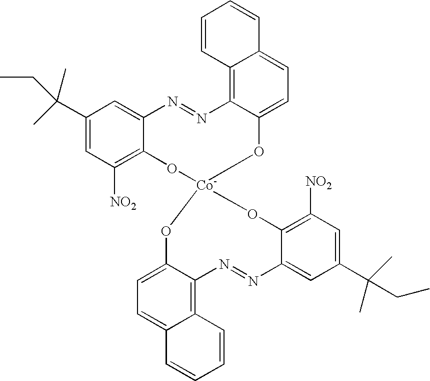 | | | |
| 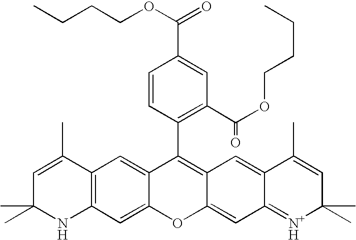 | 0.056 | 1.98 | 2.12 |
| 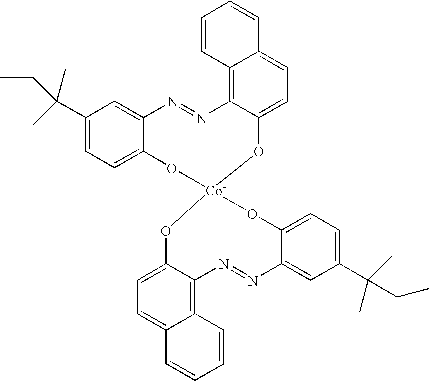 | | | |
| 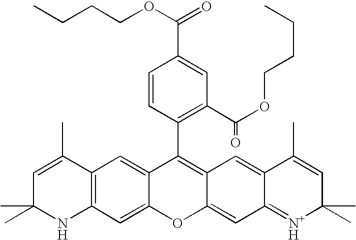 | 0.094 | 2.05 | 2.18 |
| 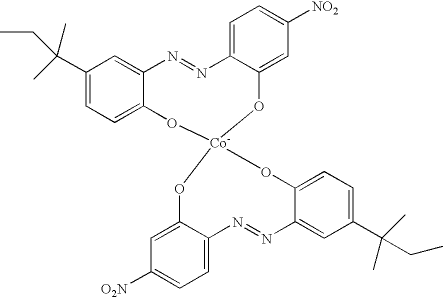 | | | |
| 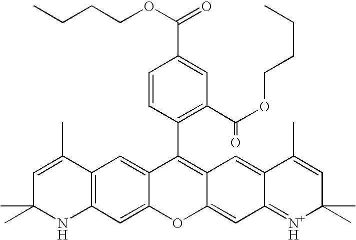 | 0.045 | 2.04 | 2.22 |
| 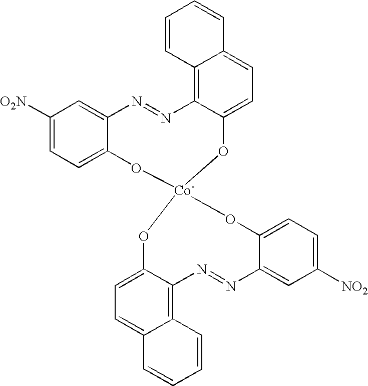 | | | |
| 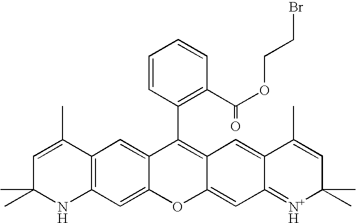 | 0.043 | 2.14 | 2.42 |
| 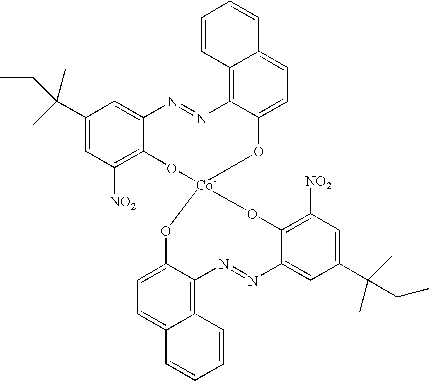 | | | |
| 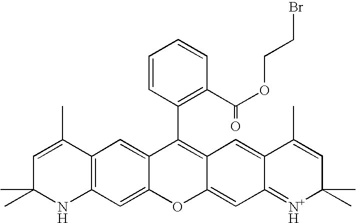 | 0.069 | 2.17 | 2.38 |
| 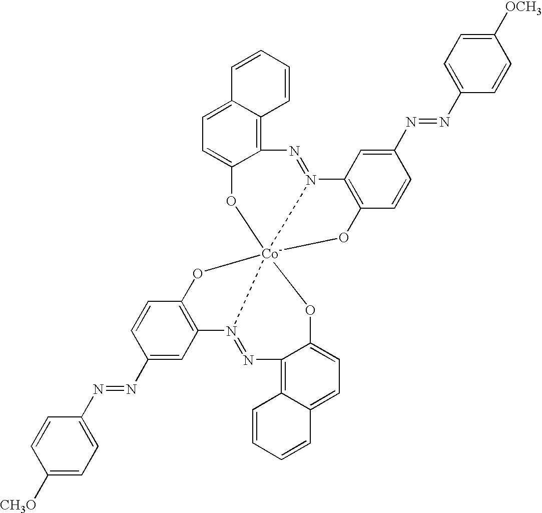 | | | |
| 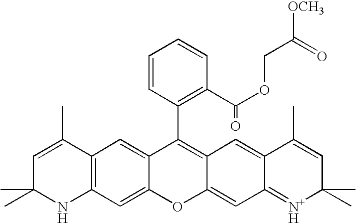 | 0.037 | 2.18 | 2.50 |
| 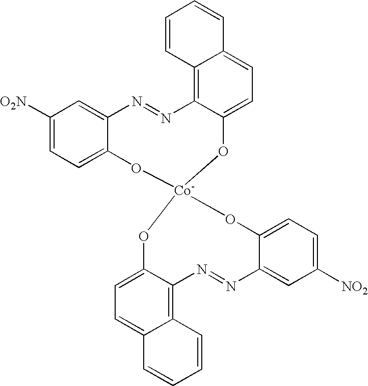 | | | |
| 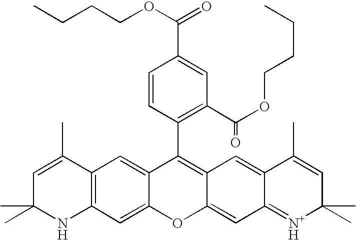 | 0.045 | 2.08 | 2.21 |
| 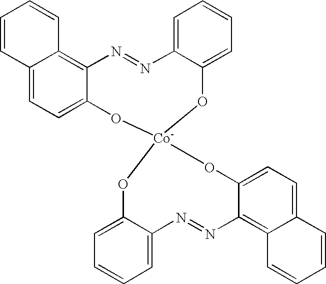 | | | |
| 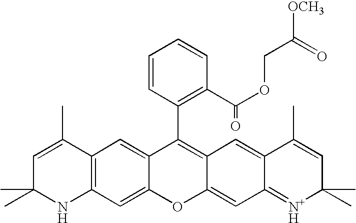 | 0.067 | 2.14 | 2.37 |
| 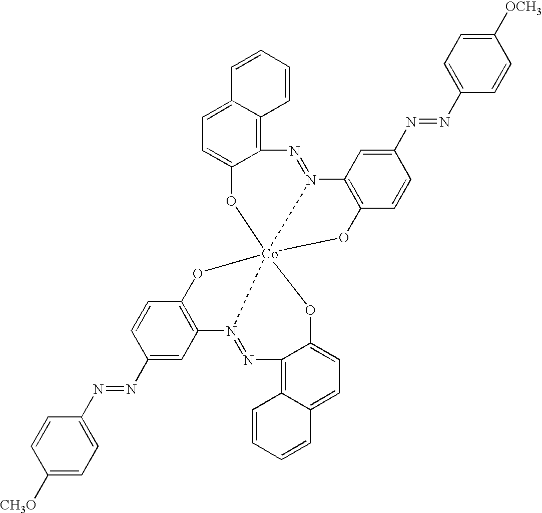 | | | |
| 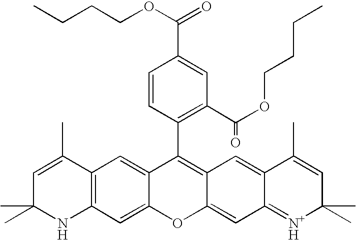 | 0.085 | 2.08 | 2.23 |
| 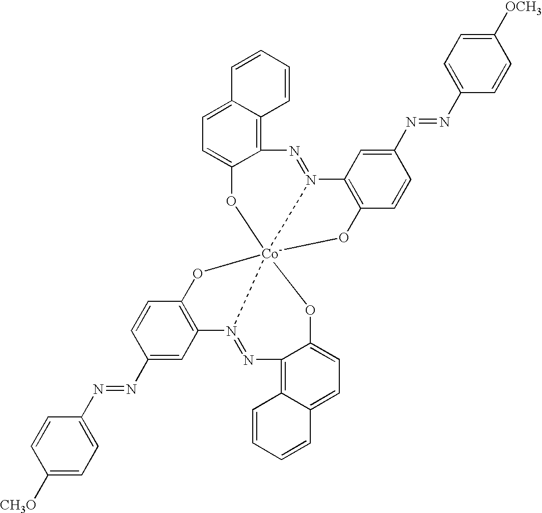 | | | |
| 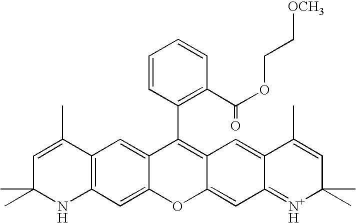 | 0.058 | 2.08 | 2.26 |
| 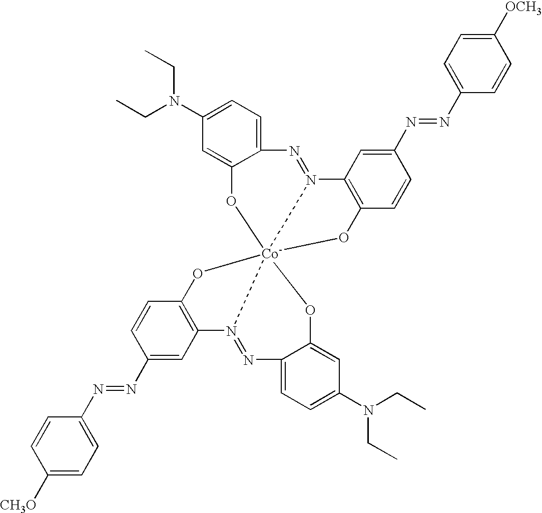 | | | |
| 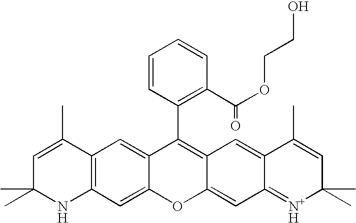 | 0.064 | 2.26 | 2.49 |
| 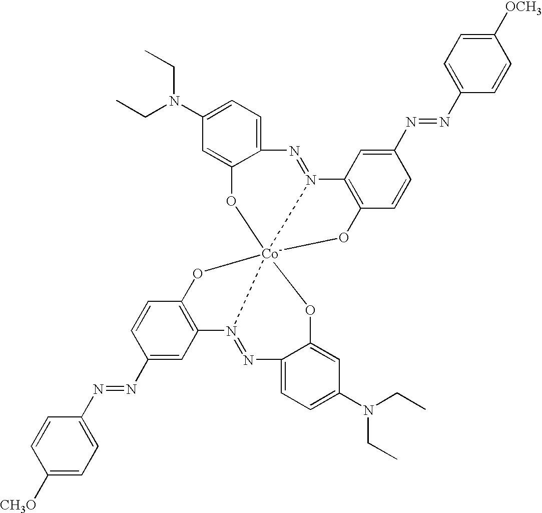 | | | |
| 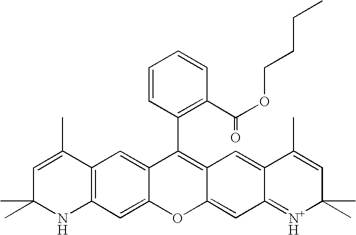 | 0.051 | 2.24 | 2.49 |
| 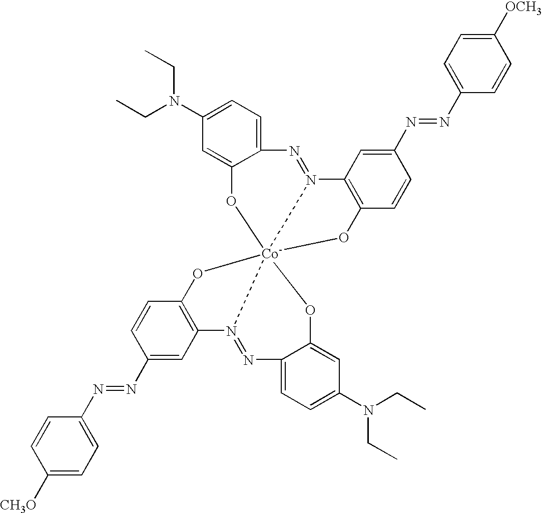 | | | |
| 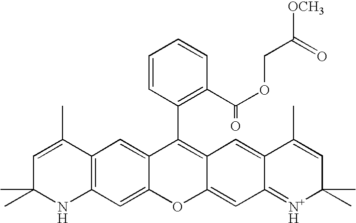 | 0.061 | 2.13 | 2.32 |
| 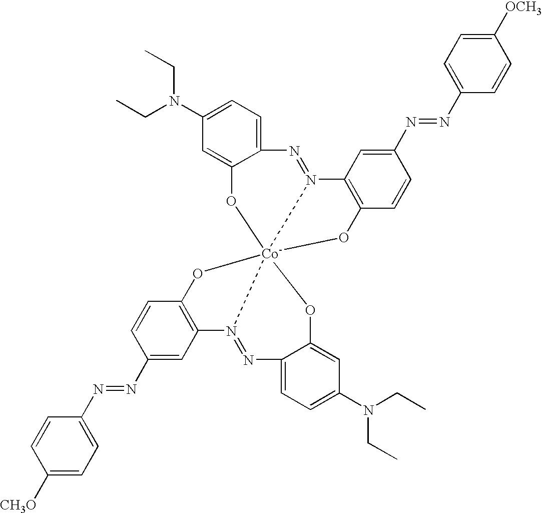 | | | |
| 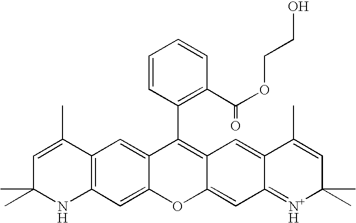 | 0.069 | 2.19 | 2.43 |
| 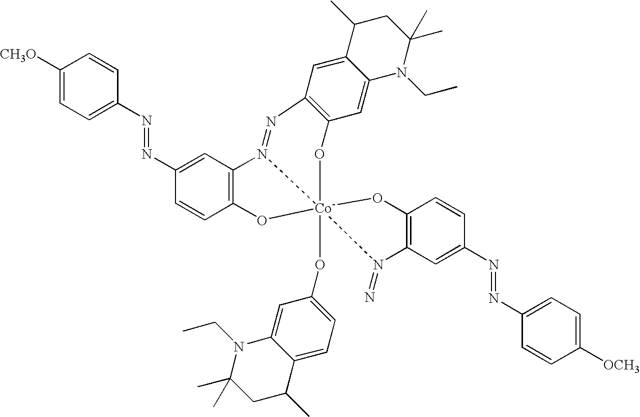 | | | |
| 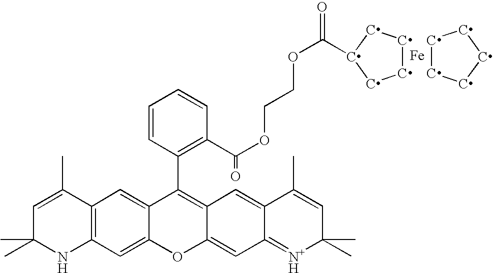 | 0.043 | 2.17 | 2.42 |
| 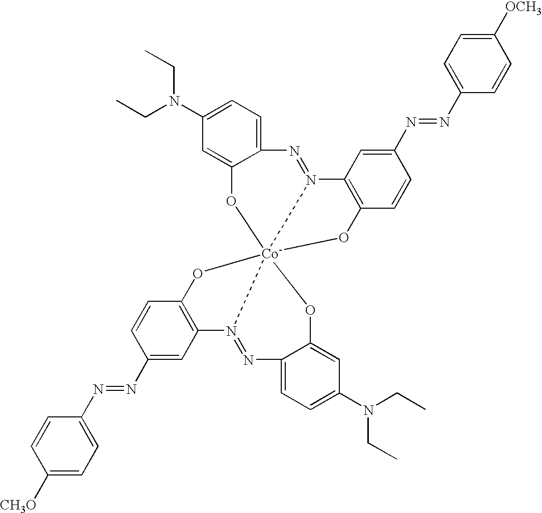 | | | |
| 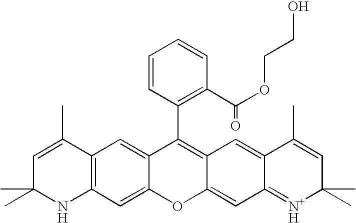 | 0.038 | 2.15 | 2.41 |
| 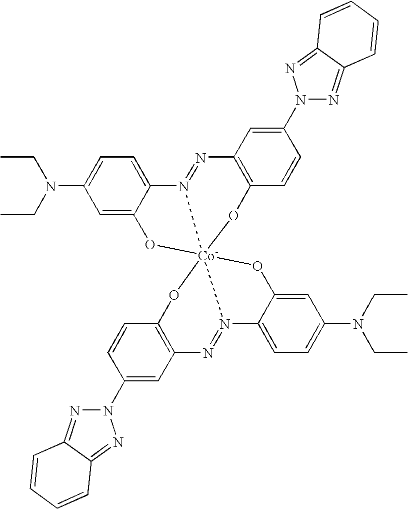 | | | |
| 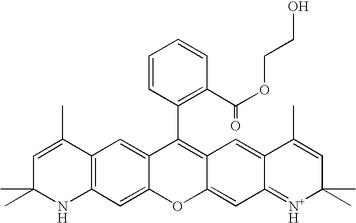 | 0.047 | 2.24 | 2.50 |
| 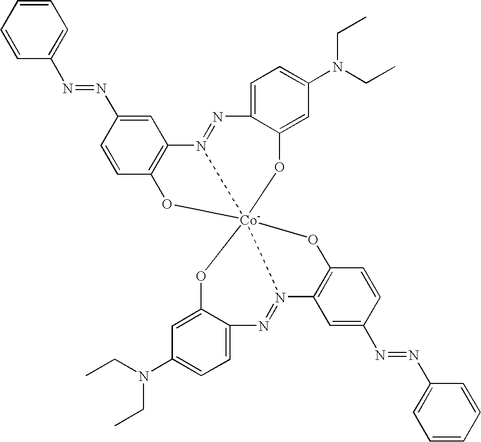 | | | |
| 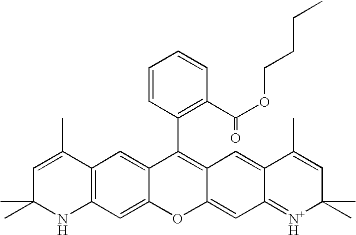 | 0.053 | 2.26 | 2.51 |
| 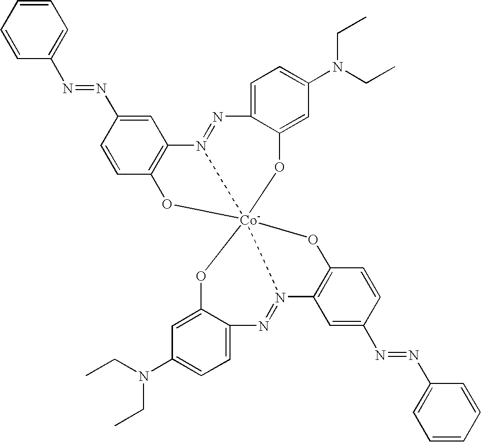 | | | |
| 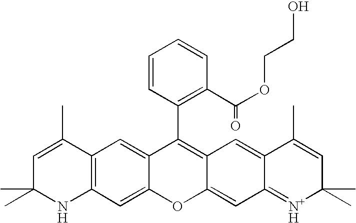 | 0.051 | 2.23 | 2.48 |
| 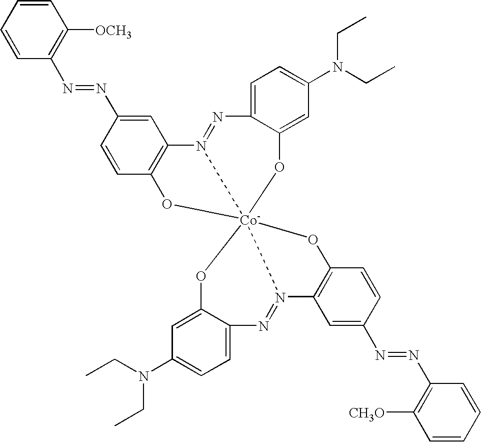 | | | |
| 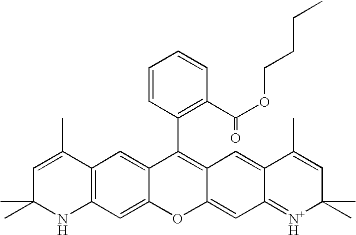 | 0.051 | 2.24 | 2.51 |
| 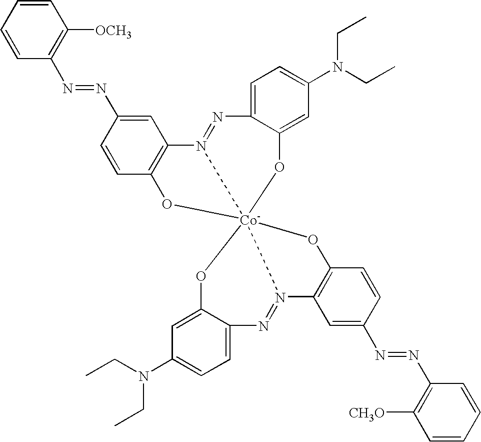 | | | |
| 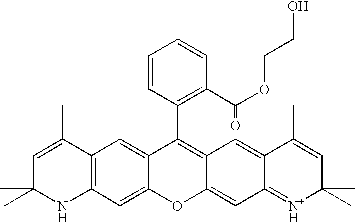 | 0.033 | 2.22 | 2.55 |
| 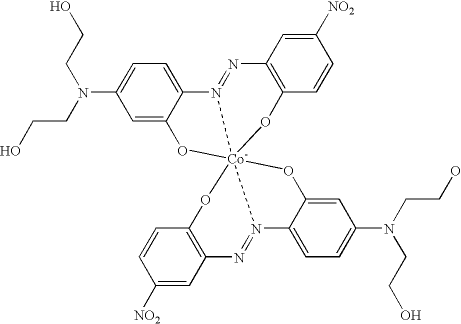 | | | |
| 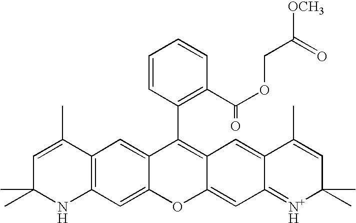 | 0.035 | 2.20 | 2.51 |
| 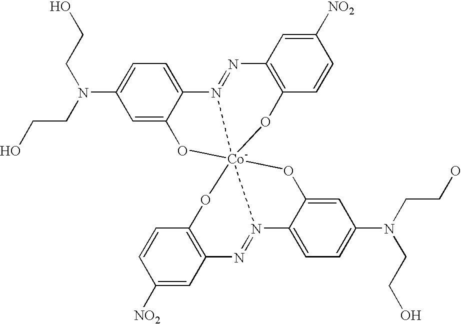 | | | |
| 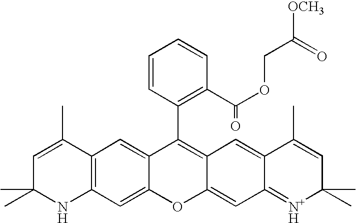 | 0.039 | 2.22 | 2.47 |
| 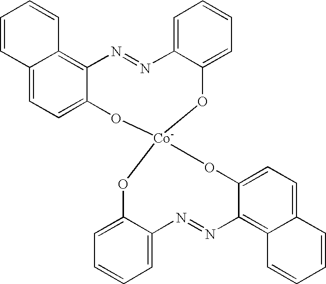 | | | |
| 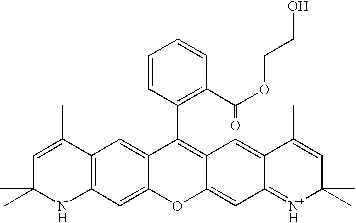 | 0.055 | 2.25 | 2.52 |
| 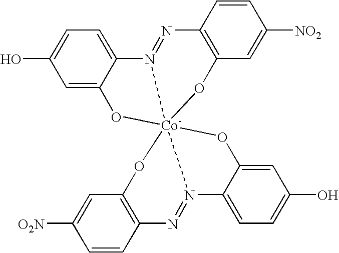 | | | |
| 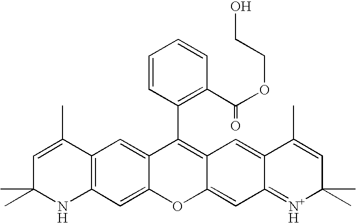 | 0.047 | 2.26 | 2.50 |
| 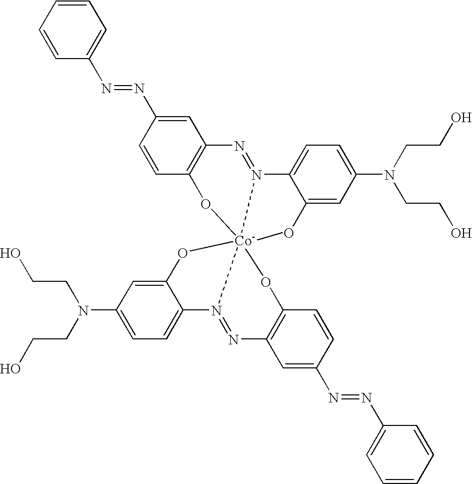 | | | |

### EXAMPLE 48

### 1.0 Part By Weight of the Compound of Formula

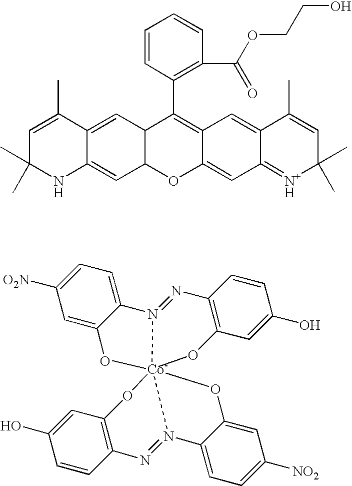 is dissolved in 99 parts by weight of 2,2,3,3-tetrafluor-1-propanol and filtered through a 0.2 μm Teflon filter. The dye solution is then applied onto a 0.6 mm thick grooved polycarbonate disc (groove depth 170 nm, groove width 330 nm, track pitch 740 nm, diameter 120 mm) at 250 revs/min and spin coating is subsequently carried out at 1500 revs/min. A uniform solid layer is obtained which, after drying 15 minutes at 70° C., has an absorbance of 0.52 at λₘₐₓ599 nm. In a vacuum sputter apparatus (Twister™, Balzers Unaxis) an 80 nm thick silver layer is then applied. Subsequently, a 5 μm thick UV-curable protective layer (650-020™, DSM) is applied. Using a disc testing apparatus (DDU-1000™, Pulstec Industrial Co., Ltd.) incorporated with a laser of 658 nm and an 0.6 NA Pickup, the so-formed optical recording medium is recorded with a linear velocity of 3.49 m/s (1×) and 11.5 mW laser power. Once recorded, the optical recording medium is evaluated in a commercial disc tester (DVD Pro, Audio Dev, AB) and the following parameters are measured: Reflectivity R14H, I14/I14H, DC Jitter. The test results are overall good.

### EXAMPLE 49

### It is Proceeded in Analogy to Example 48, With the Difference that a Mixture of 0.40 Parts by Weight of the Compound of Formula

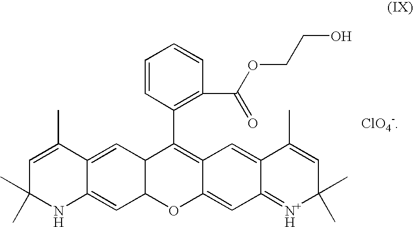 and 0.60 parts by weight of the compound of formula 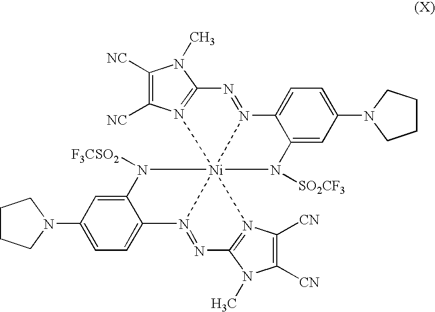
is used.

### EXAMPLES 50-55

It is proceeded as in example 49, with the difference that the quantities of the dyes of formulae (IX) and (X) are varied within a range of concentrations: 0.1 (IX)/0.9 (X); 0.2 (IX)+0.8 (X); 0.3 (IX)+0.7 (X); 0.5 (IX)+0.5 (X); 0.6 (IX)+0.4 (X) and 0.7 (IX)+0.3 (X). The results are satisfactory.

### EXAMPLES 56-62

It is proceeded as in examples 49-55, with the difference that 0.2 parts by weight of the compound of formula 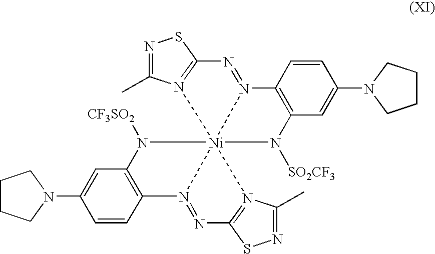
are additionally used, while the quantity of the compound of formula (X) is simultaneously decreased by 0.2 parts. The weight ratio of compounds (X) and (XI) is preferably from 1:5 to 5:1, especially about 7:3. Binary and ternary mixtures of the instant compounds with compounds of formulae (X) and/or (XI) have good solubilities in most solvents used in the field, such as for example 1-methoxy-2-propanol, propanol/cyclopentanol, propanol/1-methoxy-2-propanol or 1-methoxy-2-propanol/cyclopentanol (each preferably from 90:10 to 99:0.5).

### EXAMPLES 63-76

It is proceeded as in examples 49-62, with the difference that the compound of example 48 is used instead of the compound of formula (IX).

### EXAMPLE 77

It is proceeded in analogy to examples 48-76, with the difference that an equimolar mixture of the compound of formula (IX) and the compound of formula 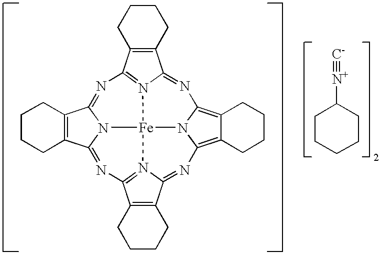
is used.

Further mixtures of 2, 3, 4, 5, 6, 7, 8, 9 or more any above-mentioned compounds can be done. The instant compounds can advantageously be used in combination with any present or future recording dye known for use in the field.

1. An optical recording medium comprising a substrate, a reflecting layer and a recording layer, wherein the recording layer comprises a compound of formula 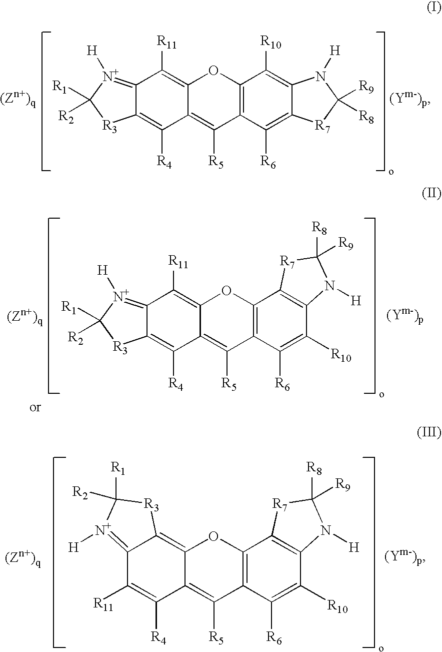
wherein R₁, R₂, R₈ and R₉ are each independently of the others C₁-C₁₂alkyl unsubstituted or mono- or poly-substituted by halogen, OR₁₂, SR₁₂, NO₂, CN, NR₁₃R₁₄, COOR₁₅, SO₃⁻, SO₃H or by SO₃R₁₂, wherein R₁ and R₂ and/or R₈ and R₉ may be bonded to one another in pairs, via a direct bond or a bridge —O—, —S— or —NR₁₆—, in such a manner that a 5- to 12-membered ring is formed; R₃ and R₇ are each independently of the other(s) C₁-C₃alkylene or C₂-C₃alkenylene each unsubstituted or mono- or poly-substituted by halogen, R₁₆, OR₁₆, SR₁₆, NO₂, CN, NR₁₇R₁₈, COOR₁₆, SO₃⁻, SO₃H or by SO₃R₁₆;
R₄, R₆, R₁₀ and R₁₁ are each independently of the others hydrogen, halogen, OR₁₉, SR₁₉, NO₂, NR₁₉R₂₀; or C₁-C₂₄alkyl, C₂-C₂₄alkenyl, C₂-C₂₄alkynyl, C₃-C₂₄cycloalkyl, C₃-C₂₄cycloalkenyl or C₇-C₁₈aralkyl each unsubstituted or mono- or poly-substituted by halogen, OR₁₉, SR₁₉, NO₂, CN or by NR₁₉R₂₀;
R₅ is hydrogen; (CH₂)ₖCOOR₂₁, C₁-C₂₄alkyl, C₂-C₂₄alkenyl, C₂-C₂₄alkynyl, C₃-C₂₄cycloalkyl or C₃-C₂₄cycloalkenyl each unsubstituted or mono- or poly-substituted by halogen, NR₂₁R₂₂ or by OR₂₂;
or C₇-C₁₈aralkyl or C₆-C₁₄aryl each unsubstituted or mono- or poly-substituted by halogen, NO₂, CN, NR₂₁R₂₂, SO₃⁻, SO₃R₂₁, SO₂NR₂₁R₂₂, (CH₂)ₖOR₂₁, (CH₂)ₖOCOR₂₁, COOR₂₁, CONR₂₁R₂₂, OR₂₁, SR₂₁, PO₃⁻, PO(OR₂₁)(OR₂₂) or by SiR₁₅R₂₃R₂₄;
R₁₂, R₁₃, R₁₄, R₁₆, R₁₇, R₁₈, R₁₉, R₂₀, R₂₁ and R₂₂ are each independently of the others hydrogen;
C₁-C₂₄alkyl, C₂-C₂₄alkenyl, C₂-C₂₄alkynyl, C₃-C₂₄cycloalkyl, C₃-C₂₄cycloalkenyl or C₃-C₁₂hetero-cycloalkyl each unsubstituted or mono- or poly-substituted by halogen, NO₂, CN, NR₁₅R₂₃, NR₁₅R₂₃R₂₄⁺, NR₁₅COR₂₃, NR₁₅CONR₂₃R₂₄, OR₁₅, SR₁₅, COOR₁₅, CHO, CR₁₅OR₂₃OR₂₄, COR₁₅, SO₂R₁₅, SO₃⁻, SO₃H, SO₃R₁₅ or by OSiR₁₅R₂₃R₂₄; or C₇-C₁₈aralkyl, C₆-C₁₄aryl or C₅-C₁₃heteroaryl each unsubstituted or mono- or poly-substituted by halogen, NO₂, CN, NR₁₅R₂₃, NR₁₅R₂₃R₂₄⁺, NR₁₅COR₂₃, NR₁₅CONR₂₃R₂₄, R₁₅, OR₁₅, SR₁₅, CHO, CR₁₅OR₂₃OR₂₄, COR₁₅, SO₂R₁₅, SO₃⁻, SO₂NR₁₅R₂₃, COOR₂₄, CONR₁₅R₂₃, PO₃⁻, PO(OR₁₅)(OR₂₃), SiR₁₅R₂₃R₂₄, OSiR₁₅R₂₃R₂₄ or by SiOR₁₅OR₂₃OR₂₄, or NR₁₃R₁₄, NR₁₇R₁₈, NR₁₉R₂₀ or NR₂₁R₂₂ is a five- or six-membered heterocycle which may contain an additional N or O atom and may be mono- or poly-substituted by C₁-C₈alkyl;
R₁₅, R₂₃ and R₂₄ are each independently of the others hydrogen, C₁-C₂₀alkyl, C₂-C₂₀alkenyl, C₂-C₂₀alkynyl or C₇-C₁₈aralkyl, wherein R₁₅ and R₂₃ may be bonded to one another, via a direct bon or a bridge —O—, —S— or —NC₁—C₈alkyl-, in such a manner that a five- or six-membered ring is formed;
wherein optionally from 1 to 4 radicals selected from the group consisting of R₁, R₂, R₃, R₄, R₅, R₆, R₇, R₈, R₉, R₁₀, R₁₁, R₁₂, R₁₃, R₁₄, R₁₅, R₁₆, R₁₇, R₁₈, R₁₉, R₂₀, R₂₁, R₂₂, R₂₃ and R₂₄ can be bonded to one another in pairs, via a direct bond or a bridge —O—, —S— or —N(G)-, or separately to Y^{m-} and/or Zⁿ⁺, G being mono- or poly-substituted C₁-C₂₄alkyl, C₂-C₂₄alkenyl, C₂-C₂₄alkynyl, C₃-C₂₄cycloalkyl, C₃-C₂₄cycloalkenyl, C₃-C₁₂heterocycloalkyl, C₇-C₁₈aralkyl, C₆-C₁₄aryl or C₅-C₁₃heteroaryl;
Y^{m-} is an inorganic, organic or organometallic anion, or a mixture thereof;
Zⁿ⁺ is a proton or a metal, ammonium or phosphonium cation, or a mixture thereof;
k is an integer from 1 to 10;
m, n and o are each independently of the others an integer from 1 to 3; and
p and q are each a number from 0 to 4, the ratio of o, p and q to one another, depending on the charge of the associated sub-structures, being such that there is no excess positive or negative charge in formula (I), (II) or (III).

2. An optical recording medium according to claim 1 comprising a compound of formula (I), (II) or (III) that comprises a sub-structure of formula 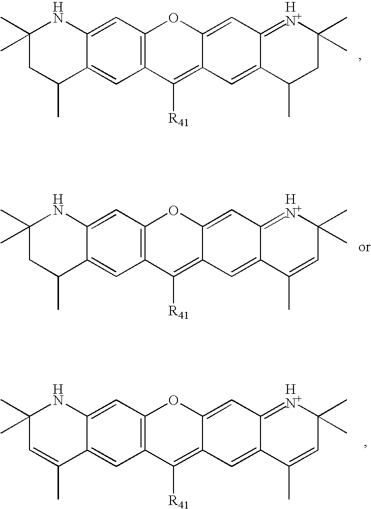
wherein R₄₁ is

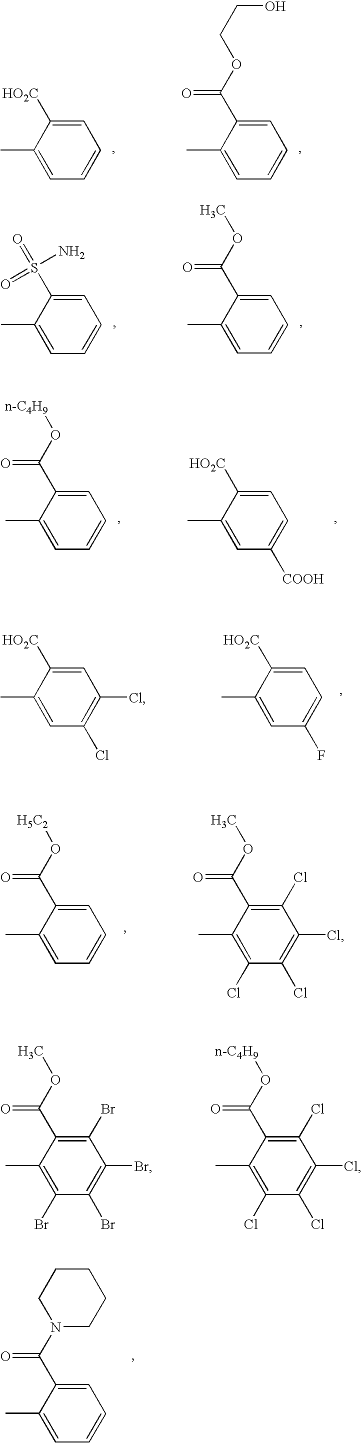

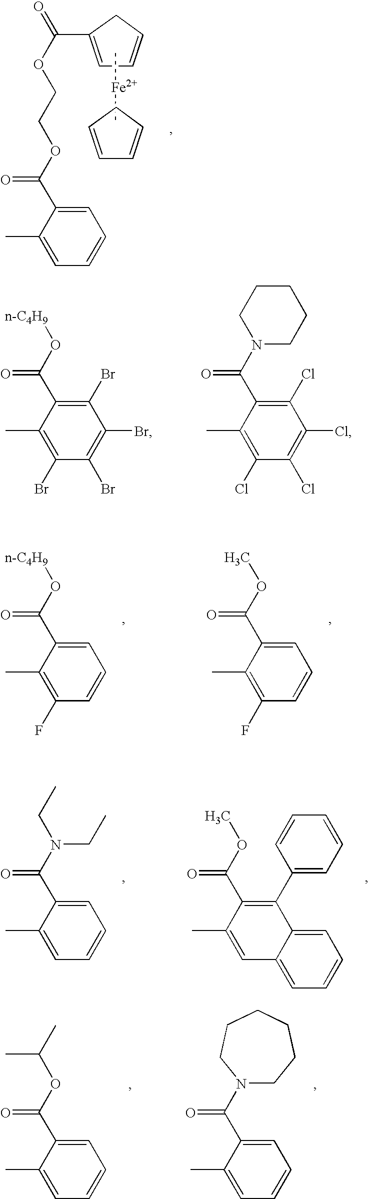

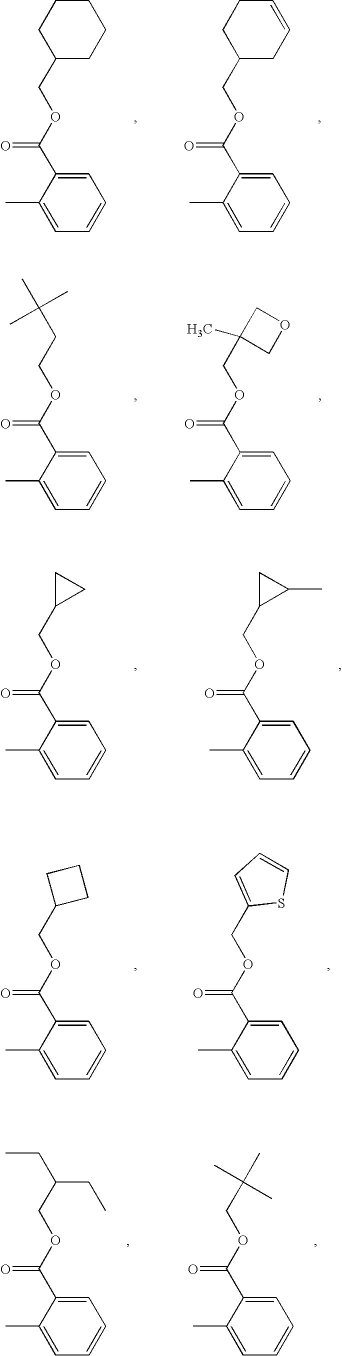

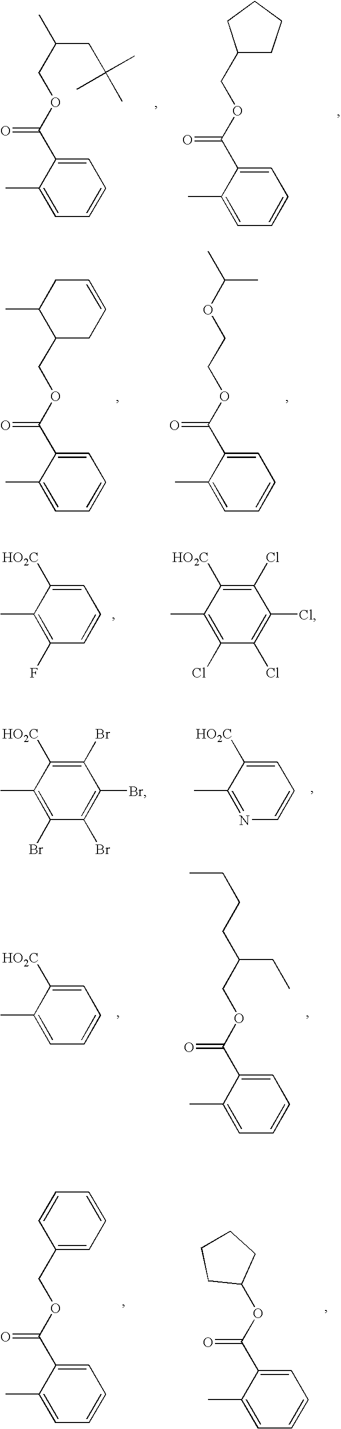

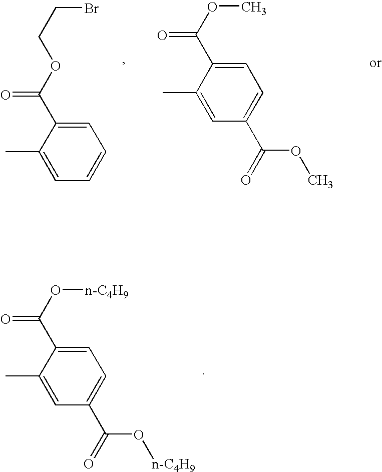

3. An optical recording medium according to claim 1, wherein Y^{m-} is a transition metal complex anion that contains at least one phenolic or phenylcarboxylic azo compound as ligand, m is an integer 1 or 2 and p is a number from 0 to 2.

4. An optical recording medium according to claim 3, wherein Y^{m-} has the formula
[(L₁)M₁(L₂)]^{m-} (IV)
or [(L₃)M₂(L₄)]⁻ (V),
wherein M₁ and M₂ are a transition metal, for example Ni²⁺, Co²⁺ or Cu²⁺, M₁ preferably being Cr³⁺ or Co³⁺ and M₂ preferably being Ni²⁺, Co²⁺ or Cu²⁺, m is a number from 1 to 6, and L₁ and/or L₂ have the formula 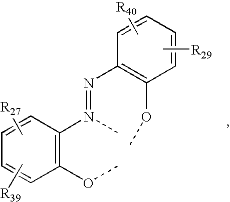
wherein R₃₉ is OH, OR₃₅, SR₃₅ or NR₃₅R₃₈ and R₄₀ is NO₂, CN, 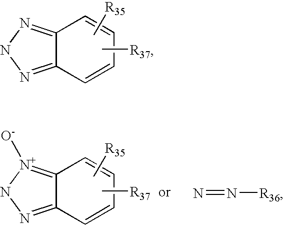
R₂₇ and R₂₉ are each independently of the other hydrogen, halogen, cyano, R₃₅, NO₂, OH, OR₃₅, SH, SR₃₅, NR₃₅R₃₈, NHCO—R₃₅, NHCOO—R₃₅, SO₂—R₃₅, SO₂NH₂, SO₂NH—R₃₅ or SO₂NR₃₅R₃₈, preferably hydrogen, chlorine, SO₂NH₂ or SO₂NHR₃₅; R₃₅ and R₃₈ are each independently of the other unsubstituted or hydroxy-, halo-, sulfato-, C₁-C₆alkoxy-, C₁-C₆alkylthio-, C₁-C₆alkylamino- or di-C₁-C₆alkylamino-substituted C₁-C₁₂alkyl, C₁-C₁₂alkoxy-C₂-C₁₂alkyl, C₇-C₁₂aralkyl or C₆-C₁₂aryl, preferably C₁-C₄alkyl; R₃₆ is C₆-C₁₂aryl unsubstituted or substituted by hydroxy, halogen, sulfato, C₁-C₆alkoxy, C₁-C₆alkylthio, C₁-C₆alkylamino or by di-C₁-C₆alkylamino and R₃₇ is nitro, chlorine, SO₂NH₂, SO₂NHR₃₅, SO₂NR₃₅R₃₈, CN, CONH₂, CONHR₃₅, CONR₃₅R₃₈, COOR₃₄ or COR₃₅ or R₃₅ and R₃₈ together are C₄-C₁₀heterocycloalkyl; it being possible for C₁-C₆alkoxy, C₁-C₆alkylthio, C₁-C₆alkyl-amino and/or di-C₁-C₆alkylamino to be unsubstituted or substituted by hydroxy or by C₁-C₄alkoxy.

5. A method of optically recording, storing or playing back information, wherein writina or reading of data is carried out on a recording medium according to claim 1.

6. A method according to claim 5, wherein recording and/or playback are carried out in a wavelength range of from 600 to 700 nm.

7. A method for preparing a compound of formula 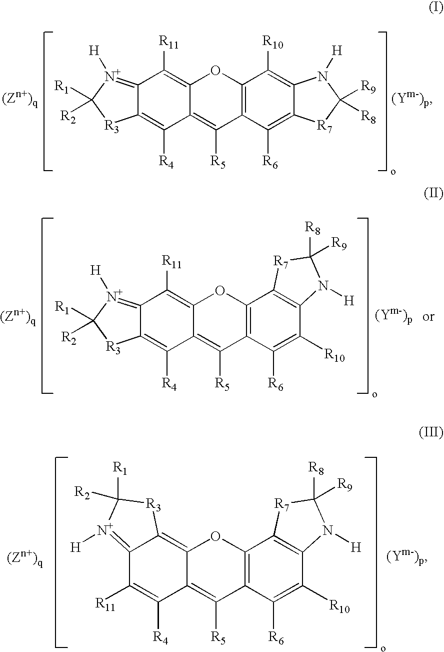
wherein Y^{m-} is an organometallic anion and the other symbols are as defined in claim 1, by addition of a compound of formula M₃⁺ Y^{m-} wherein M₃ is Li, Na, K or H3NR₅ to a compound of formula (I), (II) or (III) wherein Y^{m-} is perchlorate.

8. A method of applying a dye solution to a grooved support material by spin-coating, wherein the dye solution comprises a compound of formula (I), (II) or (III) and, as solvent, a compound of formula 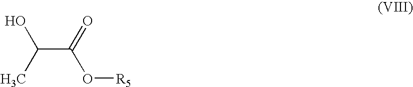
where R₅ has the same definitions as in claim 1.

9. A method according to claim 8, wherein the solvent contains from 1 to 100% by weight of the compound of formula (VIII) based on total solvent.

10. An optical recording medium according to claim 2, wherein Y^{m-} is a transition metal complex anion that contains at least one phenolic or phenylcarboxylic azo compound as ligand, m is an integer 1 or 2 and p is a number from 0 to 2.

11. An optical recording medium according to claim 10, wherein Y^{m-} has the formula
[(L₁)M₁(L₂)]^{m-} (IV)
or [(L₃)M₂(L₄)]⁻ (V),
wherein M₁ and M₂ are a transition metal, for example Ni²⁺, Co²⁺ or Cu²⁺, MI₁ preferably being Cr³⁺ or Co³⁺ and M₂ preferably being Ni²⁺, Co²⁺ or Cu²⁺, m is a number from 1 to 6, and L₁ and/or L₂ have the formula 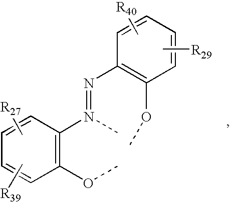
wherein R₃₉ is OH, OR₃₅, SR₃₅ or NR₃₅R₃₈ and R₄₀ is NO₂, CN, 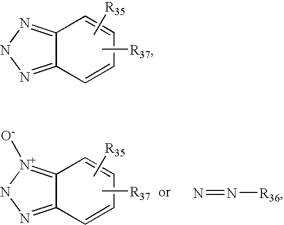
R₂₇ and R₂₉ are each independently of the other hydrogen, halogen, cyano, R₃₅, NO₂, OH, OR₃₅, SH, SR₃₅, NR₃₅R₃₈, NHCO—R₃₅, NHCOO—R₃₅, SO₂—R₃₅, SO₂NH₂, SO₂NH—R₃₅ or SO₂NR₃₅R₃₈, preferably hydrogen, chlorine, SO₂NH₂ or SO₂NHR₃₅; R₃₅ and R₃₈ are each independently of the other unsubstituted or hydroxy-, halo-, sulfato-, C₁-C₆alkoxy-, C₁-C₆alkylthio-, C₁-C₆alkylamino- or di-C₁-C₆alkylamino-substituted C₁-C₁₂alkyl, C₁-C₁₂alkoxy-C₂-C₁₂alkyl, C₇-C₁₂aralkyl or C₆-C₁₂aryl, preferably C₁-C₄alkyl; R₃₆ is C₆-C₁₂aryl unsubstituted or substituted by hydroxy, halogen, sulfato, C₁-C₆alkoxy, C₁-C₆alkylthio, C₁-C₆alkylamino or by di-C₁-C₆alkylamino and R₃₇ is nitro, chlorine, SO₂NH₂, SO₂NHR₃₅, SO₂NR₃₅R₃₈, CN, CONH₂, CONHR₃₅, CONR₃₅R₃₈, COOR₃₄ or COR₃₅ or R₃₅ and R₃₈ together are C₄-C₁₀heterocycloalkyl; it being possible for C₁-C₆alkoxy, C₁-C₆alkylthio, C₁-C₆alkyl-amino and/or di-C₁-C₆alkylamino to be unsubstituted or substituted by hydroxy or by C₁-C₄alkoxy.

12. A method of optically recording, storing or playing back information, wherein writing or reading of data is carried out on a recording medium according to claim 2.

13. A method according to claim 6, wherein recording and/or playback are carried out in a wavelength range of from 630 to 690 nm.

14. A method according to claim 12, wherein recording and/or playback are carried out in a wavelength range of from 600 to 700 nm.

15. A method according to claim 12, wherein recording and/or playback are carried out in a wavelength range of from 630 to 690 nm.
